(19) United States
(12) Patent Application Publication
(10) Pub. No.: US 2023/0341791 A1
(43) Pub. Date: Oct. 26, 2023

(54) TONER SET FOR ELECTROSTATIC CHARGE IMAGE DEVELOPMENT, IMAGE FORMING SYSTEM AND IMAGE FORMING METHOD

(71) Applicant: Konica Minolta, Inc., Tokyo (JP)

(72) Inventors: Keisuke ASANO, Tokyo (JP); Kazuhiko NAKAJIMA, Tokyo (JP)

(21) Appl. No.: 18/299,769

(22) Filed: Apr. 13, 2023

(30) Foreign Application Priority Data
Apr. 22, 2022 (JP) 2022-070486

(51) Int. Cl. G03G 9/09; G03G 9/087

(52) U.S. Cl. CPC G03G 9/0926; G03G 9/08711

(57) ABSTRACT

Provided is a toner set for developing an electrostatic charge image, including a first toner and a second toner whose toner matrix particles contain different types of pigments, wherein the first toner matrix particles included in the first toner and the second toner matrix particles included in the second toner both contain at least the pigment and a crystalline resin; and the first toner and the second toner satisfy the following specific Expressions (1A) and (2A),

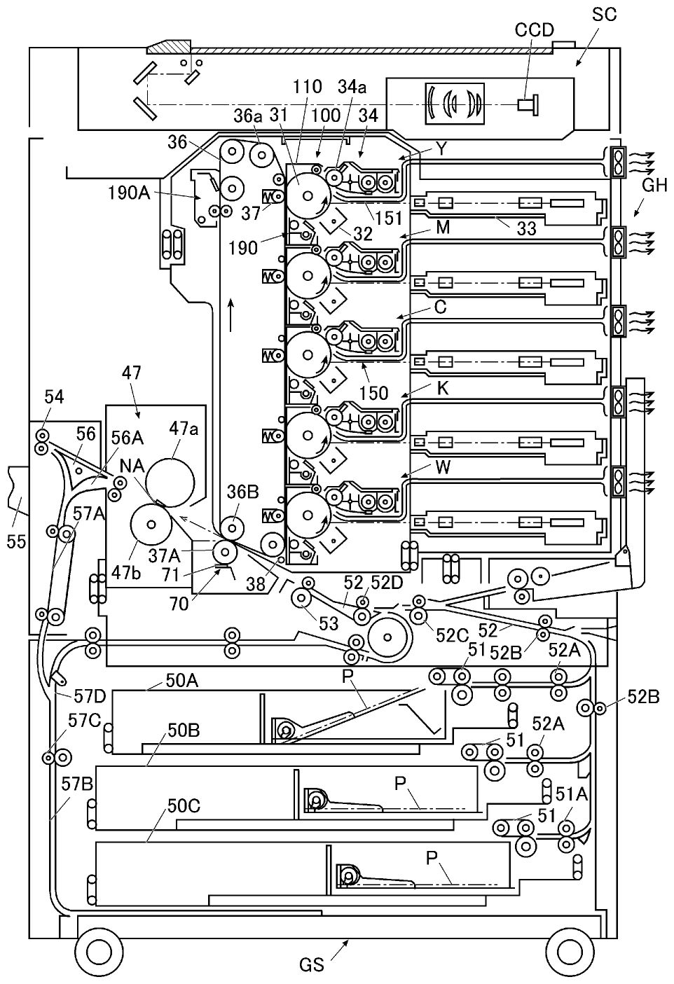

10≤W_{P1}−W_{P2} Expression (1A)

ΔH_{C1}/ΔH_{C2}≤0.15. Expression (2A)

### REFERENCE TO RELATED APPLICATIONS

The entire disclosure of Japanese Patent Application No. 2022-070486, filed on Apr. 22, 2022, including description, claims, drawings and abstract is incorporated herein by reference in its entirety.

### TECHNICAL FIELD

The present invention relates to a toner set for electrostatic charge image development, an image forming system, and an image forming method. More particularly, the present invention relates to a toner set for electrostatic charge image development for multi-color printing using toners with different pigment content and excellent in color development, heat storage resistance, and fixing properties.

### DESCRIPTION OF THE RELATED ART

Each toner in the toner set for electrostatic charge image development (hereinafter simply referred to as a “toner set”) contains a different type of pigment. The pigment content of each toner may be adjusted according to the type of pigment, taking into account color development and other factors.

For example, Patent Document 1 (JP-A 2012-177763) describes an example of image formation using a colored toner and a white toner, where the carbon black content in the colored toner is 6 mass %, while the titanium dioxide content in the white toner is adjusted relatively high at 18 to 52 mass % to improve whiteness and gloss.

On the other hand, different pigment content rates result in different degrees of reduction in thermal melting properties due to filler effects, resulting in differences in the thermal melting properties of each toner. Specifically, toners with higher pigment content tend to have better heat storage resistance, but worse fixing properties. Conversely, toners with low pigment content tend to have better fixing properties, but worse thermal storage properties.

Such differences in the thermal melting characteristics of each toner are disadvantageous in terms of toner set management and image formation. Therefore, there is a need for toner sets that have good heat storage and fixing properties even if they have different pigment content for color development.

### SUMMARY OF THE INVENTION

The present invention was made in view of the above problems and circumstances, and an object of the present invention is to provide a toner set for electrostatic charge image development, which is for multicolor printing using toners with different pigment contents, and excellent in color development, heat storage, and fixing properties, and also to provide an image forming system and image forming method using this toner set.

As a result of investigating the cause of the above-described problems in order to solve the problems, the inventor found that by including a crystalline resin in the toner matrix particles of both of a first toner and a second toner, and by controlling the ratio of the peak endothermic value ΔH_{C} [kJ/g] derived from the crystalline resin, the color development, thermal storage resistance, and fixing property may be improved. In other words, the above issues related to the present invention are solved by the following means.

An aspect of the present invention is a toner set for developing an electrostatic charge image, including a first toner and a second toner whose toner matrix particles contain different types of pigments, wherein the first toner matrix particles included in the first toner and the second toner matrix particles included in the second toner both contain at least the pigment and a crystalline resin; and the first toner and the second toner satisfy the following

10≤W_{P1}−W_{P2} Expression (1A)

ΔH_{C1}/ΔH_{C2}≤0.15 Expression (2A)

W_{P1}: a pigment content of the first toner matrix particle [mass %]

W_{P2}: a pigment content of the second toner matrix particle [mass %]

ΔH_{C1}: a peak endothermic value derived from the crystalline resin of the first toner matrix particle [kJ/g]

ΔH_{C2}: a peak endothermic value derived from the crystalline resin of the second toner matrix particle [kJ/g].

The above means of the present invention enable to provide a toner set for electrostatic charge image development, which is for multi-color printing using toners with different pigment contents, and excellent in color development, heat storage resistance, and fixability, as well as enable to provide an image forming system and an image forming method using this set.

The mechanism of the effect or mechanism of action of the invention is not clear, but is inferred as follows.

As mentioned above, toners with high pigment content tend to be difficult to melt due to the large filler effect, resulting in poor fixing performance. In response to this, by making the peak endothermic value ΔH_{C} [kJ/g] derived from the crystalline resin of the toner matrix particles relatively low, the amount of heat required for melting may be reduced, so that melting may be controlled to become easier and fixing may be improved.

On the other hand, toners with low pigment content tend to melt easily and have poor heat storage resistance due to the low filler effect. In response to this, by making the peak endothermic value ΔH_{C} [kJ/g] derived from the crystalline resin of the toner matrix particles relatively high, the amount of heat required for melting may be increased, thus making it possible to control the melting to be less likely to occur and improving thermal storage resistance.

In the present invention, it is important not only to achieve a good balance of heat storage resistance and fixability in each toner, but also to eliminate differences in heat storage resistance and fixability between toners with different pigment contents that constitute the toner set.

In the invention described in Patent Document 1, the ratio of the heat absorption value Q1 derived from the crystalline resin of the white toner to the heat absorption value Q2 derived from the crystalline resin of the colored toner (Q1/Q2) is controlled to be between 0.2 and 0.8, but this is a control to reduce the gloss difference between the white image and colored image, it did not eliminate the differences in heat storage resistance and fixability between toners.

In contrast, the present invention controls the ratio of the peak endothermic value derived from the crystalline resin ΔH_{C1} of the first toner matrix particle to the peak endothermic value derived from the crystalline resin ΔH_{C2} of the second toner matrix particle (ΔH_{C1}/ΔH_{C2}) to 0.15 or less, so as to satisfy Expression (1A). It is possible to eliminate differences in heat storage resistance and fixing properties even when the pigment content differs by more than 10 mass %.

The above means may eliminate differences in heat storage resistance and fixability between toners with different pigment content, while maintaining a good balance of heat storage resistance and fixability in each toner. It is believed that the toner set of the present invention has good color development, thermal storage resistance, and fixing property due to this mechanism.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein: the figure is a cross-sectional schematic diagram of an example of an imaging system.

### DETAILED DESCRIPTION

Hereinafter, one or more embodiments of the present invention will be described with reference to the drawings. However, the scope of the invention is not limited to the disclosed embodiments.

The toner set for developing an electrostatic charge image of the present invention is a toner set for developing an electrostatic charge image that includes a first toner and a second toner whose toner matrix particles contain different types of pigments, wherein both the first toner matrix particles included in the first toner and the second toner matrix particles included in the second toner contain at least the pigment and a crystalline resin, and the first toner and the second toner satisfy Expressions (1A) and (2A) described above. This feature is a technical feature common to or corresponding to the following embodiments.

As an embodiment of the electrostatic charge image developing toner set, it is preferred that the first and second toners satisfy the following Expression (2B) in terms of thermal storage resistance and fixability.

ΔH_{C1}/ΔH_{C2}≤0.08 Expression (2B)

As an embodiment of the toner set for electrostatic charge image development of the present invention, it is preferred that the peak endothermic value ΔH_{C2} derived from the crystalline resin of the second toner matrix particle is in the range of 8 to 15 kJ/g in terms of thermal storage resistance and fixability.

As an embodiment of the toner set for electrostatic charge image development of the present invention, it is preferred that the pigment content W_{P1} of the first toner matrix particle is more than 30 mass % from the viewpoint of obtaining the effect of the present invention remarkably.

As an embodiment of the toner set for electrostatic charge image development of the present invention, it is preferred that the crystalline resin content W_{C2} of the second toner matrix particle is in the range of 5 to 10 mass % in terms of thermal storage resistance and fixability.

As an embodiment of the toner set for electrostatic charge image development of the present invention, it is preferred that the pigment content W_{P2} of the second toner matrix particle is in the range of 2 to 10 mass % in order to obtain a pronounced effect of the invention.

As an embodiment of the toner set for electrostatic charge image development of the present invention, it is preferable from the viewpoint of obtaining a remarkable effect of the present invention that the pigment contained by the second toner matrix particles is an organic pigment, and the pigment contained by the first toner matrix particles is an inorganic pigment.

An image forming system of the present invention is an image forming system using a toner set for electrostatic charge image development, and the toner set for electrostatic charge image development is the toner set for electrostatic charge image development of the present invention.

The image forming method of the present invention is an image forming method using a toner set for electrostatic charge image development. The toner set for electrostatic charge image development is the toner set for electrostatic charge image development according to the present invention.

Hereinafter, the present invention, its constituent elements, and embodiments and modes for carrying out the present invention will be described in detail. In the present application, “to” is used to mean that the numerical values before and after “to” are included as the lower limit and the upper limit.

### <1. Outline of Toner Set for Developing an Electrostatic Charge Image>

The toner set of the present invention is a toner set for electrostatic charge image development including a first toner and a second toner whose toner matrix particles contain different types of pigments, wherein the first toner matrix particles included in the first toner and the second toner matrix particles included in the second toner both contain at least the pigment and a crystalline resin, and wherein the first toner and the second toner satisfy the following Expressions (1A) and (2A).

10≤W_{P1}−W_{P2} Expression (1A)

ΔH_{C1}/ΔH_{C2}≤0.15 Expression (2A)

W_{P1}: a pigment content of the first toner matrix particle [mass %]

W_{P2}: a pigment content of the second toner matrix particle [mass %]

ΔH_{C1}: a peak endothermic value derived from the crystalline resin of the first toner matrix particle [kJ/g]

ΔH_{C2:} a peak endothermic value derived from the crystalline resin of the second toner matrix particle [kJ/g]

The toner set includes at least a first toner and a second toner with different pigment types contained in the toner matrix particles, but may further include other toners.

In the present invention, the term “toner” refers to an aggregate of toner particles. In addition, “toner particles” refers to toner matrix particles to which an external additive is added. In the present invention, toner particles may be simply referred to as toner particles when there is no need to distinguish between toner matrix particles and toner particles.

### <1.1. Pigment Content of Toner Matrix Particles>

The toner set of the present invention is characterized in that the pigment content Wpi of the first toner matrix particle and the pigment content W_{P2} of the second toner matrix particle satisfy the following Expression (1A).

10≤W_{P1}−W_{P2} Expression (1A)

Expression (1A) represents that in the present invention, the toner with a higher pigment content of the toner matrix particles is a first toner and the toner with a lower pigment content of the toner matrix particles is a second toner, and that each pigment content differs by more than 10 mass %. The pigment content of each toner is adjusted respectively for color development, and the toner set of the present invention is thus tasked with further improving thermal storage resistance and fixability in a toner set that includes toners with different pigment content for color development.

In the present invention, the “pigment content of toner matrix particles” is the content of pigment when the total amount of each component of the toner matrix particles is 100 mass %.

Generally, the larger the difference in pigment content ratio, the larger the difference in heat storage resistance and fixing performance, making it more difficult to achieve good heat storage resistance and fixing performance as a toner set. In contrast, the toner set of the present invention is characterized by its ability to eliminate differences in heat storage resistance and fixability even when the differences in pigment content are large, and is particularly effective when the differences in pigment content are large. Therefore, from this point of view, it is preferable that the pigment content ratio W_{P1} of the first toner matrix particle and the pigment content ratio W_{P2} of the second toner matrix particle satisfy the following Expression (1B).

20≤W_{P1}−W_{P2} Expression (1B)

In terms of the respective pigment content, the pigment content W_{P1} of the first toner matrix particle is preferably at least 30 mass % and less than 60 mass %. The pigment content W_{P2} of the second toner matrix particle is preferably in the range of 2 to 10 mass %.

<1.2. Peak Endothermic Value Derived from the Crystalline Resin of Toner Matrix Particles>

The toner set of the present invention is characterized in that the crystalline resin-derived peak endothermic value ΔH_{C1} of the first toner matrix particle and the crystalline resin-derived peak endothermic value ΔH_{C2} of the second toner matrix particle satisfy the following Expression (2A).

ΔH_{C1}/ΔH_{C2}≤0.15 Expression (2A)

Expression (2A) indicates that the ratio of the peak heat absorption derived from the crystalline resin of the toner matrix particles (ΔH_{C1}/ΔH_{C2}) is less than 0.15.

This makes the toner set of the present invention have a small difference in thermal storage resistance and fixing property, and the toner set has excellent thermal storage resistance and fixing property.

From the viewpoint of obtaining better heat storage resistance and fixability, the peak endothermic value derived from the crystalline resin of the first toner matrix particle and the peak endothermic value ΔH_{C2} derived from the crystalline resin of the second toner matrix particle preferably satisfy the following Expression (2B).

ΔH_{C1}/ΔH_{C2}≤0.08 Expression (2B)

In terms of the respective peak endothermic values, the peak endothermic value ΔH_{C1} derived from the crystalline resin of the first toner matrix particle is preferably in the range of 0.64 to 1.2 kJ/g, and the peak endothermic value ΔH_{C2} derived from the crystalline resin of the second toner matrix particle is preferably in the range of 8 to 15 kJ/g.

The peak endothermic value ΔH_{C} derived from a crystalline resin may be measured by the following method according to ASTM D3418-8 with reference to Patent Document 1 (JP-A 2012-177763).
(1) Place 10 mg of sample (toner) in an aluminum cell and cover it with a lid (this is called the sample cell). For comparison, 10 mg of alumina is placed in the same type of aluminum cell and covered with a lid (this is called the comparison cell).
(2) Set the sample cell and the comparison cell in the measurement device respectively, raise the temperature from 30° C. to 200° C. at a rate of 10° C./minute under a nitrogen atmosphere, and leave them at 200° C. for 10 minutes. At this time, the endothermic and exothermic curves are obtained.
(3) After leaving the sample to stand, the temperature is lowered to −30° C. using liquid nitrogen at a descending rate of −10° C./min.
(4) After leaving the sample to stand, increase the temperature from −30° C. to 200° C. at a rate of 20° C./min. At this time, the endothermic and exothermic curves are again obtained.

Compare the endothermic and exothermic curves obtained during operations (2) and (4), and determine that endothermic peaks in the ±5° C. range are endothermic peaks derived from the same material.

Based on Section 9 of JIS-K7122, the peak endothermic value per mass of the sample determined from the peak area surrounded by the baseline and the endothermic peak is defined as the peak endothermic value determined from the endothermic peak.

Among the endothermic peaks derived from the same material, an endothermic peak whose ratio (B/A) of the peak endothermic value A determined from the endothermic peak obtained in operation (2) to the peak endothermic value B determined from the endothermic peak obtained in operation (4) is less than 0.8 is judged as an endothermic peak derived from the crystalline resin.

Of the endothermic and exothermic curves obtained during the operation in (2), the peak endothermic value obtained from the crystalline resin-derived endothermic peak is adopted as the crystalline resin-derived peak endothermic value AHc.

A Perkin Elmer DSC-7 differential scanning calorimeter may be used as a measurement device.

### <2. Composition of Toner>

The first toner and the second toner of the present invention include toner matrix particles as a constituent. The first toner and the second toners may also include an external additive as a constituent.

### <2.1. Toner Matrix Particles>

In the present invention, the toner matrix particles included in the first toner are referred to as the first toner matrix particles, and the toner matrix particles included in the second toner are referred to as the second toner matrix particles. Both the first toner matrix particle and the second toner matrix particle are characterized in that they contain at least a pigment and a crystalline resin, and may further contain an amorphous resin and a wax.

### <2.1.1. Pigments>

The types of pigments that may be used in the present invention are not limited, and for example, the following pigments may be used.

Examples of organic yellow or orange pigments include C.I. Pigment Orange 31, C.I. Pigment Orange 43, C.I. Pigment Yellow 12, C.I. I. Pigment Yellow 13, C.I. Pigment Yellow 14, C.I. Pigment Yellow 15, C.I. Pigment Yellow 17, C.I. Pigment Yellow 74, C.I. Pigment Yellow 93, C.I. Pigment Yellow 94, C.I. Pigment Yellow 138, C.I. Pigment Yellow 155, C.I. Pigment Yellow 180, and C.I. Pigment Yellow 185.

Examples of organic magenta or red pigments include C.I. Pigment Red 2, C.I. Pigment Red 3, C.I. Pigment Red 5, C.I. Pigment Red 6, C.I. Pigment Red 7, C.I. Pigment Red 15, C.I. Pigment Red 16, C.I. Pigment Red 48;1, C.I. Pigment Red 53;1, C.I. Pigment Red 57;1, C.I. Pigment Red 122, C.I. Pigment Red 123, C.I. Pigment Red 139, C.I. Pigment Red 144, C.I. Pigment Red 149, C.I. Pigment Red 150, C.I. Pigment Red 166, C.I. Pigment Red 177, C.I. Pigment Red 178, C.I. Pigment Red 184, C.I. Pigment Red 222, and C.I. pigment red 238

Examples of organic cyan or blue pigments include C.I. Pigment Blue 15, C.I. Pigment Blue 15;2, C.I. Pigment Blue 15;3, C.I. Pigment Blue 15;4, C.I. Pigment Blue 16, C.I. Pigment Blue 60, C.I. Pigment Blue 62, C.I. Pigment Blue 66, and C.I. Pigment Green 7.

Organic black pigments include carbon black. Examples of carbon black include channel black, furnace black, acetylene black, thermal black, and lamp black.

Inorganic black pigments include magnetic materials and titanium black. Examples of magnetic materials include ferromagnetic metals such as iron, nickel, and cobalt, alloys containing these ferromagnetic metals, compounds of ferromagnetic metals such as ferrite and magnetite, and alloys that do not contain ferromagnetic metals but exhibit ferromagnetism by heat treatment. Alloys that exhibit ferromagnetism by heat treatment include, for example, Heusler alloys such as manganese-copper-aluminum and manganese-copper-tin, and chromium dioxide.

Organic white pigments include polystyrene resin particles, urea-formalin resin particles, and hollow resin particles.

Examples of the inorganic white pigment include heavy calcium carbonate, light calcium carbonate, titanium dioxide (titanium dioxide), aluminum hydroxide, titanium white, talc, calcium sulfate, barium sulfate, zinc oxide, magnesium oxide, magnesium carbonate, amorphous silica, colloidal silica, white carbon, kaolin, calcined kaolin, delaminated kaolin, aluminosilicate, sericite, bentonite, smexite, and hollow silica.

Examples of the inorganic glitter pigment include metal powders such as aluminum, brass, bronze, nickel, stainless steel, zinc, copper, silver, gold, and platinum; mica coated with titanium dioxide or yellow iron oxide; coated flaky inorganic crystal substrates such as barium sulfate, layered silicate, layered aluminum silicate, single-crystal platelet titanium oxide, and basic carbonates, acid bismuth oxychloride, natural guanine, flaky glass powder, metal deposited flaky glass powder, and pearl pigments.

Examples of the organic fluorescent pigment include polyphenyl, stilbene, oxazole, oxadiazole, coumarin, xanthene, oxazine, thiazine, and polymethine.

Examples of the inorganic fluorescent pigment include compounds in which metal oxides represented by Y₂O₃ or Zn₂SiO₄, phosphates represented by Sr₅(PO₄)₃Cl, sulfides represented by ZnS, SrS, or CaS is used as a crystal matrix, and this crystal matrix is combined with rare earth metal ions such as Ce, Pr, Nd, Pm, Sm, Eu, Gd, Tb, Dy, Ho, Er, Tm, Yb and other rare earth metal ions, and metal ions such as Ag, Al, Mn, and Sb as activators or coactivators. Preferred examples of crystal matrices are, for example, YO₃, Y₂O₃, Y₂O₂S, Y₂SiO₃, YAlO₃, Y₃Al₅O₁₂, (Y, Gd)₃Al₅O₁₂, SnO₂, Zn₂SiO₄, Sr₄Al₁₄O₂₅, CeMgAl₁₁O₁₉, BaAl₁₂O₁₉, BaAl₂Si₂O₈, BaMgAl₁₀O₁₇, BaMgAl₁₄O₂₃, Ba₂Mg₂A₁₁₂O₂₂, Ba₂Mg₄Al₈O₁₈, Ba₃Mg₅Al₁₈O₃₅, (Ba, Sr, Mg)O aAl₂O₃, (Ba, Sr)(Mg, Mn)Al₁₀O₁₇, (Ba, Sr, Ca)(Mg, Zn, Mn)Al₁₀O₁₇, (Y, Gd)BO₃, GdMgB₅O₁₀, Sr₂P₂O₇, (La, Ce)PO₄, Ca₅(PO₄)₃Cl, Ca₁₀(PO₄)₆(F, Cl)₂, (Sr, Ca, Ba, Mg)₁₀(PO₄)₆C₁₂, ZnS, (Zn,Cd)S, CaS, SrS, and SrGa₂S₄. The above crystal matrices and activators or coactivators are not restricted in elemental composition and may be partially replaced with elements of the same family. These inorganic fluorescent pigments are preferably those that absorb ultraviolet light and emit visible light.

The average particle size of pigments other than glitter pigments is preferably in the range of 10 to 1,000 nm, and 50 to 500 nm is more preferred. The average particle size of glitter pigments is preferably in the range of 10 to 10,000 nm.

The shape of the glitter pigment may be, for example, flat (scale-like).

The average length of the long axis direction of the glitter pigment is preferably in the range of 1 to 30 μm, 3 to 20 μm is more preferred, and 5 to 15 μm is even more preferred.

The aspect ratio (ratio of the average length in the longitudinal direction to the average length in the thickness direction set to 1) of the glitter pigment is preferably in the range of 5 to 200, 10 to 100 is more preferred, and 30 to 70 is even more preferred.

The average length in the long axis direction and the average length in the thickness direction of the glitter pigment may be measured by determining the average number of glitter pigments in 1000 pieces using SEM images taken at a measurable magnification (300 to 100,000×). S-4800 manufactured by Hitachi High-Technologies Corporation may be used for the scanning electron microscope to take SEM images.

From the viewpoint of color development, it is preferable that the pigment content is relatively high in the case of inorganic pigments. Therefore, in the toner set of the present invention, it is preferable that the pigments contained by the first toner matrix particles with high pigment content is inorganic pigments and the pigments contained by the second toner matrix particles with low pigment content is organic pigments.

### <2.1.2. Binder Resin>

The first and second toner matrix particles of the present invention contain a crystalline resin as a binder resin. This controls the ratio of the peak endothermic value ΔH_{C} [kJ/g] derived from the crystalline resin described above. In addition, an amorphous resin may be further included as a binder resin.

The term “crystalline resin” refers to a resin that has a clear endothermic peak at the melting point, i.e., when the temperature rises, in the endothermic curve obtained by differential scanning calorimetry (DSC). A clear endothermic peak means a peak with a half value width of 15° C. or less in the endothermic curve when the temperature is increased at a rate of 10° C./min.

On the other hand, the term “amorphous resin” refers to a resin that does not show a clear endothermic peak described above in the endothermic curve obtained by differential scanning calorimetry as described above, although a baseline curve indicating that a glass transition has occurred may be seen.

### (Crystalline Resin)

The crystalline resin content of the toner matrix particles is not particularly limited and may be adjusted as needed to control the ratio of the peak endothermic value ΔH_{C} [kJ/g] derived from a crystalline resin described above. However, considering the pigment content and filler effect of the second and first toner matrix particles, respectively, from the viewpoint of heat storage resistance and fixability, the crystalline resin content W_{C2} of the second toner matrix particle is preferably in the range of 5 to 10 mass %. It is preferable that the crystalline resin content W_{C1} of the first toner matrix particle is in the range of 0.1 to 20 mass %.

The melting point of the crystalline resin is preferably in the range of 55 to 80° C. from the viewpoint of both fixability and thermal storage resistance, and a range between 70° C. and 80° C. is more preferable. The melting point of the crystalline resin may be measured by differential scanning calorimetry (DSC).

The molecular weight of the crystalline resin is preferably in the range of 8,500 to 12,500 for the number average molecular weight, and more preferably in the range of 9,000 to 11,000.

Types of crystalline resins are not limited, but include, for example, a polyolefin resin, a polydiene resin, and a crystalline polyester resin. Among these, a crystalline polyester resin is preferred in terms of improved fixability and ease of use. A hybrid crystalline polyester resin is also acceptable.

A crystalline polyester resin may be obtained by a polycondensation reaction of a divalent or more alcohol (polyhydric alcohol component) and a divalent or more carboxylic acid (polycarboxylic acid component).

Examples of the polyhydric alcohol component include divalent alcohols such as ethylene glycol, propylene glycol, butanediol, diethylene glycol, hexanediol, cyclohexanediol, octanediol, decanediol, dodecanediol, ethylene oxide adduct of bisphenol A, propylene oxide adduct of bisphenol A, trivalent alcohols such as glycerin, pentaerythritol, hexamethylol melamine, hexaethylol melamine, hexamethylolmelamine, hexaethylolmelamine, tetramethylolbenzoguanamine, tetraethylolbenzoguanamine, and their ester compounds, and hydroxycarboxylic acid derivatives.

Examples of the polycarboxylic acid component include divalent carboxylic acids such as oxalic acid, succinic acid, maleic acid, mesaconic acid, adipic acid, β-methyladipic acid, azelaic acid, sebacic acid, nonanedicarboxylic acid, decanedicarboxylic acid, undecanedicarboxylic acid, dodecanedicarboxylic acid, fumaric acid, citraconic acid, diglycolic acid, cyclohexane-3,5-diene-1,2-dicarboxylic acid, malic acid, citric acid, hexahydroterephthalic acid, malonic acid, pimelic acid, tartaric acid, mucilic acid, phthalic acid, isophthalic acid, terephthalic acid, tetrachlorophthalic acid, chlorophthalic acid, nitrophthalic acid, p-carboxyphenyl acetic acid, p-phenylene diacetic acid, m-phenylenediglycolic acid, p-phenylenediglycolic acid, m-phenylenediglycolic acid, o-phenylenediglycolic acid, diphenylacetic acid, diphenyl-p,p′-dicarboxylic acid, naphthalene-1,4-dicarboxylic acid, naphthalene-1,5-dicarboxylic acid, naphthalene-2,6-dicarboxylic acid, anthracenedicarboxylic acid, dodecenyl succinic acid; and tri or more valent carboxylic acids such as trimellitic acid, pyromellitic acid, naphthalenetricarboxylic acid, naphthalenetetracarboxylic acid, pyrenetricarboxylic acid, and pyrenetetracarboxylic acid, and their alkyl esters, acid anhydrides and acid chlorides.

It is preferable that the monomers (polyhydric alcohol component and polycarboxylic acid component) constituting the crystalline polyester resin contain at least 50 mass % of linear aliphatic monomers, and it is more preferable that they contain at least 80 mass %. It is preferable to use linear aliphatic monomers because the melting point of crystalline polyesters is often higher when aromatic monomers are used, and crystallinity is often lower when branched aliphatic monomers are used. In addition, crystallinity may be maintained in the toner when linear aliphatic monomers account for 50 mass % or more, and sufficient crystallinity may be maintained when the percentage of linear aliphatic monomers is 80 mass % or more.

As for the ratio of the polyhydric alcohol component to the polycarboxylic acid component, it is preferable that the equivalent ratio of the hydroxy group of the polyhydric alcohol component to the carboxy group of the polycarboxylic acid component is in the range of 1.5/1 to 1/1.5, and it is more preferable that the ratio is in the range of 1.2/1 to 1/1.2.

It is also preferred that the carbon number of the polyhydric alcohol component (C(alcohol)) and the carbon number of the polycarboxylic acid component (C(acid)) satisfy the relationship in Expressions (A) through (C) below.

C(acid)−C(alcohol)≥4 Expression (A)

C(acid)≥10 Expression (B)

Expression (C): C(alcohol) <6

Crystalline polyester resins with a defined number of carbons in the raw material are formed using polyhydric alcohol components and polycarboxylic acids with different chain lengths in the main chain, so that branched chains with short carbon numbers and long carbon numbers are alternately bonded to the polyester chain. Therefore, it is thought that there are portions with low regularity during crystallization. Therefore, by using a crystalline polyester resin with a specified number of carbons in the raw material as the crystalline polyester resin comprising the binding resin, when thermal energy at a temperature higher than the melting point of the crystalline polyester resin is applied during thermal fixing, the crystals will melt sequentially from the parts with low regularity. This results in good fixing performance.

The relationship between C(acid) and C(alcohol) above preferably satisfy C(acid)−C(alcohol)≥4 as in the above Expression (A), but it is more preferred that C(acid)−C(alcohol)≥6.

When two or more polycarboxylic acid components are contained, the above C(acid) is the number of carbon atoms of the polycarboxylic acid component with the highest content (in terms of mol). When the amounts are the same, the number of carbon atoms in the polycarboxylic acid component having the largest number of carbon atoms is defined as C(acid).

Similarly, when two or more polyhydric alcohol components are contained, C(alcohol) above is defined as the carbon number of the polyhydric alcohol component with the highest content (in mol). In the case of equal amounts, the carbon number of the polyhydric carboxylic acid component with the highest carbon number is defined as C(alcohol).

The method for producing the crystalline polyester resin is not particularly limited, and it may be produced by polycondensing (esterifying) the polyhydric alcohol component and the polycarboxylic acid component using a known esterification catalyst.

Examples of the esterification catalyst include alkali metal compounds such as sodium and lithium, alkaline earth metal compounds such as magnesium and calcium, metal compounds such as aluminum, zinc, manganese, antimony, titanium, tin, zirconium, germanium, phosphite compounds, phosphoric acid compounds, amine compounds and others. Tin compounds include dibutyltin oxide, tin octylate, tin dioctylate, and their salts. Titanium compounds include titanium alkoxides such as tetranormal butyl titanate, tetraisopropyl titanate, tetramethyl titanate, tetrastearyl titanate, titanium acylates such as polyhydroxytitanium stearate, titanium tetraacetylacetonate titanium chelates such as titanium lactate and titanium triethanolaminate. Germanium compounds include germanium dioxide. Aluminum compounds include oxides such as polyaluminum hydroxide, aluminum alkoxide, and tributylaluminate. These may be used alone or in combination of two or more.

The polycondensation temperature and polymerization polycondensation time are not particularly limited, and the reaction system may be depressurized as necessary during polycondensation.

The crystalline polyester resin may also be a hybrid crystalline polyester resin copolymerized with a crystalline polyester polymer segment synthesized by polycondensation reaction of a polyhydric alcohol component and a polycarboxylic acid component, and an amorphous polymer segment other than a polyester resin.

The crystalline polyester polymer segment indicates the portion derived from the crystalline polyester resin. An amorphous polymer segment other than a polyester resin indicates the portion derived from an amorphous resin other than a polyester resin.

Amorphous resins other than a polyester resin include, for example, a vinyl resin, a urethane resin, and a urea resin. Among these, a vinyl resin is preferred, and a styrene acrylic resin is more preferred. One type of amorphous polymer segment other than a polyester resin may be used alone or in combination of two or more types.

The hybrid crystalline polyester resin may be in any form, such as a block copolymer or a graft copolymer, as long as it contains crystalline a polyester polymer segment and an amorphous polymer segment other than a polyester resin, but a graft copolymer is preferred. The graft copolymer makes it easier to control the orientation of the crystalline polyester polymer segment and to impart sufficient crystallinity to the hybrid crystalline polyester resin.

The crystalline polyester polymer segment is preferably grafted with an amorphous polymer segment other than a polyester resin as the main chain. In other words, the hybrid crystalline polyester resin is preferably a graft copolymer having an amorphous polymer segment other than a polyester resin as a main chain and a crystalline polyester polymer segment as a side chain. By using this structure, the orientation of the crystalline polyester polymer segment may be further enhanced, and the crystallinity of the hybrid crystalline polyester resin may be improved.

The hybrid crystalline polyester resin may further have substituents such as a sulfonic acid group, a carboxy group, and a urethane group introduced into them. The introduction of these substituents may be in the crystalline polyester polymer segment or in an amorphous polymer segment other than a polyester resin.

When the crystalline polyester resin is a hybrid crystalline polyester resin, the content of the crystalline polyester polymer segment is preferably between 50 and 98 mass % of the total amount of the hybrid crystalline polyester resin. By setting the content in the above range, sufficient crystallinity may be imparted to the hybrid crystalline polyester resin. The constituents and content of each polymer segment in the hybrid crystalline polyester resin may be identified, for example, by NMR measurement and methylation reaction P-GC/MS measurement.

The method of making hybrid crystalline polyester resins is not particularly restricted as long as it is possible to copolymerize a crystalline polyester polymer segment with an amorphous polymer segment other than a polyester resin. Specific production methods for hybrid crystalline polyester resins include, for example, the following methods.
(A) A crystalline polyester polymer segment is polymerized in advance, then, reacting the crystalline polyester polymer segment with a bi-reactive monomer, and further reacting a monomer for forming an amorphous polymer segment other than a polyester resin to form an amorphous polymer segment other than a polyester resin is formed.
(B) An amorphous polymer segment other than a polyester resin is polymerized in advance, then, reacting the amorphous polymer segment with a bi-reactive monomer, and further reacting a polyhydric carboxylic acid component and a polyhydric alcohol component for forming a crystalline polyester polymer segment to form a crystalline polyester polymer segment.
(C) A crystalline polyester polymer segment and an amorphous polymer segment other than a polyester resin are polymerized in advance, and then, reacting these two segments with a bi-reactive monomer to bond these two segments.

The “bi-reactive monomer” is a monomer that combines the crystalline polyester polymer segment and the amorphous polymer segment other than a polyester resin, and has in its molecule both a group selected from a hydroxy group, a carboxy group, an epoxy group, a primary amino groups, and a secondary amino group that form the crystalline polyester polymer segment and an ethylenically unsaturated group that forms a styrene-acrylic polymer segment, both of which are present in the molecule.

Specific examples of the bi-reactive monomer include acrylic acid, methacrylic acid, fumaric acid, and maleic acid, and even their hydroxyalkyl (1 to 3 carbons) esters, although acrylic acid, methacrylic acid, or fumaric acid is preferred in terms of reactivity. The crystalline polyester polymer segment and the amorphous polymer segment other than a polyester resin are combined through the bi-reactive monomer.

From the viewpoint of improving fixability, the amount of bi-reactive monomers used is preferably 1 to 20 mass %, more preferably 5 to 15 mass %, of the total amount of monomers constituting the amorphous polymer segment other than a polyester resin.

As monomers constituting the amorphous polymer segment other than a polyester resin, there is no particular limitation, and for example, the vinyl monomers described in the section on amorphous vinyl resins below may be used.

The amorphous polymer segment other than a polyester resin is preferably a styrene-acrylic polymer segment derived from a styrene-acrylic resin. In this case, the amorphous polymer segment other than a polyester resin is formed by addition polymerization of at least a styrene monomer and a (meth)acrylic ester monomer. Styrene is preferred as the styrene monomer, and n-butyl acrylate is preferred as the (meth)acrylic ester monomer.

### (Amorphous Resin)

Amorphous resins are not particularly limited. Examples include amorphous vinyl resins and amorphous polyester resins.

The glass transition point Tg of the amorphous resin is preferably in the range of 35 to 80° C. and more preferably in the range of 45 to 65° C. from the viewpoint of maintaining a higher balance between low-temperature fixing and fixing separation.

The glass transition temperature Tg may be measured according to the DSC method described above. Differential scanning calorimeter “Diamond DSC” (Perkin Elmer), DSC-7 differential scanning calorimeter (Perkin

Elmer), and TAC7/DX thermal analyzer controller (Perkin Elmer) may be used for the measurement.

The weight average molecular weight Mw of the amorphous resin is preferably in the range of 20,000 to 150,000 from the viewpoint of easy control of the plasticity of the amorphous resin, and is more preferably in the range of 25,000 to 130,000. The number average molecular weight Mn of the amorphous resin is preferably in the range of 5,000 to 150,000 from the viewpoint of easy control of the plasticity of the amorphous resin, and it is more preferred to be in the range of 8,000 to 70,000.

The weight average molecular weight Mw of the amorphous resin may be obtained from the molecular weight distribution measured by GPC (gel permeation chromatography). Specifically, firstly, the sample solution is prepared by adding the sample to be measured to a concentration of 1 mg/mL in tetrahydrofuran, dispersing it for 5 minutes at room temperature using an ultrasonic dispersion machine, and then processing it through a membrane filter with a pore size of 0.2 μm. For example, a GPC system HLC-8120GPC (Tosoh) and columns (“TSKgel guardcolumn SuperHZ-L” and “TSKgel SuperHZM-M”, Tosoh) are used. While maintaining the column temperature at 40° C., tetrahydrofuran is poured as a carrier solvent at a flow rate of 0.2 mL/min. Inject 10 μL of the prepared sample solution together with the carrier solvent into the GPC system, detect the sample using a refractive index detector (RI detector), and calculate the molecular weight distribution of the sample using a calibration curve measured using monodisperse polystyrene standard particles. The calibration curve is prepared by measuring 10 polystyrene standard particles (manufactured by Pressure Chemical Co. Ltd.) with molecular weights of 6×10², 2.1×10³, 4×10³, 1.75×10⁴, 5.1×10⁴, 1.1×10⁵, 3.9×10⁵, 8.6×10⁵, 2×10⁶ and 4.48×10⁶, respectively.

An amorphous vinyl resin is formed by using a monomer having a vinyl group (hereinafter referred to as a “vinyl monomer”). Amorphous vinyl resins include a styrene-acrylic resin, a styrene resin, and an acrylic resin. Among them, a styrene-acrylic resin is preferred.

Examples of the vinyl monomer include styrene monomers, (meth)acrylic ester monomers, vinylester monomers, vinylether monomers, vinyl ketone monomers, and N-vinyl compound monomers.

Examples of the styrenic monomer include styrene, o-methylstyrene, m-methylstyrene, p-methylstyrene, alpha-methylstyrene, p phenylstyrene, p-ethylstyrene, 2,4-dimethylstyrene, p-tert-butylstyrene, p-n hexylstyrene, p-n-octylstyrene, p-n-nonylstyrene, p-n-decylstyrene, p-n-dodecylstyrene, and their derivatives.

Examples of the (meth)acrylic acid monomer include methyl (meth)acrylate, ethyl (meth)acrylate, n-butyl (meth)acrylate, isopropyl (meth)acrylate, isobutyl (meth)acrylate, t-butyl (meth)acrylate, n-octyl (meth)acrylate, 2-ethylhexyl (meth)acrylate, stearyl (meth)acrylate, lauryl (meth)acrylate, phenyl (meth)acrylate, diethylaminoethyl (meth)acrylate, dimethylaminoethyl (meth)acrylate and their derivatives.

Examples of the vinyl ester monomer include vinyl propionate, vinyl acetate, and vinyl benzoate.

Examples of the vinyl ether monomer include vinyl methyl ether and vinyl ethyl ether.

Examples of the vinyl ketone monomer include vinyl methyl ketone, vinyl ethyl ketone, and vinyl hexyl ketone.

Examples of the N-vinyl compound monomer include, N-vinylcarbazole, N-vinylindole, and N-vinylpyrrolidone.

Other vinyl monomers include, for example, vinyl compounds such as vinylnaphthalene and vinylpyridine, and (meth)acrylic acid derivatives such as acrylonitrile, methacrylonitrile and acrylamide.

One or more of the above vinyl monomers may be used alone or in combination.

As a vinyl monomer, it is preferable to use a monomer having ionic dissociative groups such as a carboxy group, a sulfonic acid group, and a phosphoric acid group, for example. Specifically, the following are examples.

Monomers with a carboxy group include acrylic acid, methacrylic acid, maleic acid, itaconic acid, silicic acid, fumaric acid, maleic acid monoalkyl ester, and itaconic acid monoalkyl ester.

Monomers with a sulfonic acid group include styrenesulfonic acid, allylsulfosuccinic acid, and 2-acrylamido-2-methylpropanesulfonic acid.

Monomers with a phosphate group include acidophosphooxyethyl methacrylate.

Furthermore, multifunctional vinyls may be used as a vinyl monomer to make the vinyl polymer have a cross-linked structure.

Examples of the multifunctional vinyl include divinylbenzene, ethylene glycol dimethacrylate, ethylene glycol diacrylate, diethylene glycol dimethacrylate, diethylene glycol diacrylate, triethylene glycol dimethacrylate, triethylene glycol diacrylate triethylene glycol diacrylate, neopentyl glycol dimethacrylate, and neopentyl glycol diacrylate.

The content of the amorphous vinyl resin in the toner matrix particles is not particularly limited and may be adjusted as needed to control the ratio of the peak endothermic value ΔH_{C} [kJ/g] derived from the crystalline resin described above.

Next, amorphous polyester resins will be described. Amorphous polyester resins are known polyester resins obtained by polycondensation reaction of a divalent or more carboxylic acid component (polycarboxylic acid component) and a divalent or more alcohol component (polyhydric alcohol component), which have no clear melting point and a relatively high glass transition point Tg. This may be confirmed by performing differential scanning calorimetry (DSC) on the amorphous polyester resin. It may also be distinguished from crystalline polyester resins by analysis such as NMR, for example, because it is different from the monomers that make up crystalline polyester resins.

The amorphous polyester resin is not particularly limited, and conventionally known amorphous polyester resins in this technical field may be used.

As polycarboxylic acid components constituting amorphous polyester resins, unsaturated aliphatic polycarboxylic acids, aromatic polycarboxylic acids, and their derivatives are preferred. From the viewpoint that compatibility with a crystalline polyester resin is further promoted and low temperature fixing property is improved, more preferred is to include an unsaturated aliphatic polycarboxylic acid. A saturated aliphatic polycarboxylic acid may be used in combination as long as an amorphous resin may be formed. The polycarboxylic acid component is not limited to one type, but may be a mixture of two or more types.

Examples of the unsaturated aliphatic polycarboxylic acid include unsaturated aliphatic dicarboxylic acids, unsaturated aliphatic tricarboxylic acids, and unsaturated aliphatic tetracarboxylic acids. Their lower alkyl esters and acid anhydrides may also be used. Unsaturated aliphatic dicarboxylic acids include methylene succinic acid, fumaric acid, maleic acid, 3-hexenedioic acid, 3-octenedioic acid, succinic acid substituted with an alkyl group of 1 to 20 carbon atoms or an alkenyl group of 2 to 20 carbon atoms. Unsaturated aliphatic tricarboxylic acids include 3-butene-1,2,3-tricarboxylic acid, 4-pentene-1,2,4-tricarboxylic acid and aconitic acid. Unsaturated aliphatic tetracarboxylic acids include 4-pentene-1,2,3,4-tetracarboxylic acid.

Specific examples of succinic acid substituted with alkyl groups of 1 to 20 carbon atoms or alkenyl groups of 2 to 20 carbon atoms include dodecyl succinic acid, dodecenyl succinic acid, octenyl succinic acid and decenyl succinic acid. These lower alkyl esters and acid anhydrides may also be used.

Examples of the aromatic polycarboxylic acid include aromatic dicarboxylic acids, aromatic tricarboxylic acids, aromatic tetracarboxylic acids, and aromatic hexacarboxylic acids. Their lower alkyl esters and acid anhydrides may also be used. Aromatic dicarboxylic acids include phthalic acid, terephthalic acid, isophthalic acid, t-butylisophthalic acid, tetrachlorophthalic acid, chlorophthalic acid, nitrophthalic acid, p-phenylene diacetic acid, 2,6-naphthalenedicarboxylic acid, 4,4′-biphenyldicarboxylic acid, and anthracenedicarboxylic acid. Aromatic tricarboxylic acids include 1,2,4-benzenetricarboxylic acid (trimellitic acid), 1,2,5-benzenetricarboxylic acid (trimesic acid), 1,2,4-naphthalenetricarboxylic acid, and hemimellitic acid. Aromatic tetracarboxylic acids include pyromellitic acid, and 1,2,3,4-butanetetracarboxylic acid. Aromatic hexacarboxylic acids include melitic.

Examples of the saturated aliphatic polycarboxylic acid include saturated aliphatic dicarboxylic acids (e.g., dodecanedioic acid) among the polycarboxylic acid components listed in the crystalline polyester resin section above.

The number of carbons of the dicarboxylic acid is not restricted, but in particular, a carbon number in the range of 1 to 20 is preferred, 2 to 15 is more preferred, and 3 to 12 is especially preferred, as it facilitates proper thermal properties.

The number of carbons in the trivalent or higher polycarboxylic acid component is not particularly limited, but in particular, a carbon number in the range of 3 to 20 is preferred, 5 to 15 is more preferred, and 6 to 12 is especially preferred, as it facilitates proper thermal properties.

As polyhydric alcohol components constituting amorphous polyester resin, unsaturated aliphatic polyhydric alcohols, aromatic polyhydric alcohols, and their derivatives are preferred from the viewpoint of chargeability and toner strength. Saturated aliphatic polyhydric alcohols may be used together as long as they may form amorphous polyester resins. The polyhydric alcohol component is not limited to one type, but may be a mixture of two or more types.

Unsaturated aliphatic polyhydric alcohols include, for example, 2-butene-1,4-diol, 3-butene-1,4-diol, 2-butyne-1,4-diol, 3-butene-1,4-diol, 9-octadecene-7,12-diol. Derivatives of these may also be used.

Aromatic polyhydric alcohols include, for example, bisphenols, alkylene oxide (ethylene oxide, propylene oxide) adducts of bisphenols, 1,3,5-benzentriol, 1,2,4-benzentriol, and 1,3,5-trihydroxymethylbenzene. These derivatives may also be used. Bisphenols include bisphenol A, bisphenol F, and others. Among these, the alkylene oxide adduct of bisphenol A is especially preferred from the viewpoint of improving the charge uniformity of the toner and facilitating the optimization of thermal properties.

Examples of the saturated aliphatic polyhydric alcohol include glycerin, trimethylolpropane, pentaerythritol, and sorbitol. Derivatives of these may also be used.

The number of carbons in the polyhydric alcohol component is not particularly restricted, but in particular, a carbon number in the range of 3 to 30 is preferred because it facilitates optimization of thermal properties.

The weight average molecular weight Mw of the amorphous polyester resin is not particularly restricted, but it is preferably in the range of 5,000 to 100,000, and more preferably in the range of 5,000 to 50,000. If the weight average molecular weight Mw is 5,000 or higher, the heat storage resistance of the toner may be improved, and if the weight average molecular weight Mw is 100,000 or lower, the fixing property may be further improved.

The content of the amorphous polyester resin in the toner matrix particles is not particularly limited and may be adjusted as needed to control the ratio of the peak endothermic value ΔH_{C} [kJ/g] derived from the crystalline resin described above.

The method of producing an amorphous polyester resin is not particularly restricted, and the resin may be produced by polycondensation (esterification) of the above polycarboxylic acid and polyhydric alcohol components using a known esterification catalyst.

Examples of the esterification catalyst include alkali metal compounds such as sodium and lithium, alkaline earth metal compounds such as magnesium and calcium, metal compounds such as aluminum, zinc, manganese, antimony, titanium, tin, zirconium, germanium, phosphite compounds, phosphoric acid compounds, amine compounds and others. Tin compounds include dibutyltin oxide, tin octylate, tin dioctylate, and their salts. Titanium compounds include titanium alkoxides such as tetranormal butyl titanate, tetraisopropyl titanate, tetramethyl titanate, tetrastearyl titanate, titanium acylates such as polyhydroxytitanium stearate, titanium tetraacetylacetonate titanium chelates such as titanium lactate and titanium triethanolaminate. Germanium compounds include germanium dioxide. Aluminum compounds include oxides such as polyaluminum hydroxide, aluminum alkoxide, and tributylaluminate. These may be used alone or in combination of two or more.

The temperature of polycondensation is not particularly limited, but it is preferably in the range of 150 to 250° C. The time for polycondensation is not particularly limited, but its preferably in the range of 0.5 to 15 hours. During polycondensation, the reaction system may be depressurized if necessary.

The amorphous polyester resin may also be a hybrid amorphous polyester resin copolymerized with an amorphous polyester polymer segment synthesized by polycondensation reaction between a polyhydric alcohol component and a polycarboxylic acid component and an amorphous polymer segment other than a polyester resin.

The amorphous polyester polymer segment indicates the portion derived from the amorphous polyester resin. The amorphous polymer segment other than a polyester resin indicates the portion derived from the amorphous resin other than a polyester resin.

Examples of the amorphous resins other than a polyester resin include a vinyl resin, a urethane resin, and a urea resin. Among these, a vinyl resin is preferred, and a styrene-acrylic resin is more preferred. One type of amorphous polymer segment other than a polyester resin may be used alone or in combination of two or more types.

The hybrid amorphous polyester resins may be in any form, including block copolymers and graft copolymers, as long as they contain an amorphous polyester polymer segment and an amorphous polymer segment other than a polyester resin.

The hybrid amorphous polyester resins may further have substituents such as a sulfonic acid group, a carboxy group, and a urethane group introduced into them. The introduction of these substituents may be in the amorphous the polyester polymer segment or in the amorphous polymer segment other than a polyester resin.

Methods for producing hybrid amorphous polyester resins are not restricted, as long as the copolymerization of an amorphous polyester polymer segment with an amorphous polymer segment other than a polyester resin is possible. Specific production methods for hybrid amorphous polyester resins include, for example, the following methods.
(A) An amorphous polyester polymer segment is polymerized in advance, then reacting the amorphous polyester polymer segment with a bi-reactive monomer, and further reacting with a monomer to form an amorphous polymer segment other than a polyester resin to form an amorphous polymer segment other than a polyester resin.
(B) An amorphous polymer segment other than a polyester resin is polymerized in advance, then reacting the amorphous polymer segment with a bi-reactive monomer, and further reacting a polycarboxylic acid component and a polyhydric alcohol component for forming an amorphous polyester polymer segment.
(C) A method in which the amorphous polyester polymer segment and the amorphous polymer segment other than a polyester resin are each pre-polymerized, and then both are combined by reacting them with a bi-reactive monomer.

The bi-reactive monomer and the monomer constituting the amorphous polymer segment other than a polyester resin are the same as those described above in the section on the method of making hybrid crystalline polyester resins.

The method for forming the amorphous polymer segment other than a polyester resin is not particularly restricted, and any polymerization initiator such as peroxides, persulfides, persulfates, and azo compounds that are usually used for the polymerization of the above monomers. Polymerization may be carried out by known polymerization techniques such as bulk polymerization, solution polymerization, emulsion polymerization (emulsion association method), mini-emulsion method, and dispersion polymerization method.

The content of the amorphous polyester polymer segment in the hybrid amorphous polyester resin is not particularly limited, but a range of 60 to 95 mass % is preferred, and a range of 70 to 85 mass % is more preferred.

The content of the amorphous polymer segment other than a polyester resin in the hybrid amorphous polyester resin (hereinafter also referred to as “modified amount”) is preferably in the range of 5 to 40 mass %, and more preferably in the range of 10 to 30 mass %.

The modified amount is specifically the ratio of the total mass of monomers constituting the amorphous polymer segment other than a polyester resin to the total mass of the resin material used to synthesize the hybrid amorphous polyester resin.

### <2.1.3. Wax>

The first and second toner matrix particles of the present invention may contain a wax as a mold release agent. Various known waxes may be used as waxes.

Waxes include hydrocarbon waxes such as polypropylene wax, polyethylene wax, polypropylene-polyethylene copolymer wax, microcrystalline wax, paraffin wax, Fischer-Tropsch wax, Sasol wax, and their oxides; ester waxes such as carnauba wax, montan wax, and their deacidified waxes, fatty acid ester waxes; fatty acid amides, fatty acid metal salts; fatty acid amides, fatty acids, higher alcohols, and fatty acid metal salts. These may be used alone or in combination of two or more types. Among these, carnauba wax is preferred from the viewpoint of durability.

The melting point of the wax is preferably 60° C. or more, more preferably 70° C. or more, from the viewpoint of toner transferability, and preferably 160° C. or less, more preferably 140° C. or less, more preferably 130° C. or less, and even more preferably 120° C. or less, from the viewpoint of fixability.

The melting point of wax may be measured, for example, using a differential scanning calorimeter “Q-100” (T.A. Instruments Japan, Inc.) by the following method.

First, weigh 0.01 to 0.02 g of sample into an aluminum pan, raise the temperature to 200° C. at a rate of 10° C./min, and cool to −10° C. at a rate of 5° C./min from that temperature. Next, the sample is heated to 180° C. at a rate of 10° C./min and measured. The highest peak endothermic temperature observed in the melting endothermic curve is the melting point of the wax.

The amount of wax used is preferably 0.5 parts by mass or more, more preferably 1 part by mass or more, and even more preferably 1.5 parts by mass or more per 100 parts by mass of the binder resin, from the viewpoints of toner fixability and offset resistance and dispersibility in the binder resin, and is preferably 15 parts by mass or less, more preferably 10 parts by mass or less, and even more preferably 7 parts by mass or less.

### <2.1.4. Other Additives>

The first and second toner matrix particles according to the present invention may contain other additives as necessary. Other additives include charge control agents, magnetic powders, fluidity improvers, conductivity modifiers, reinforcing fillers such as fibrous materials, antioxidants, and cleanability improvers.

Charge control agents are not limited as long as they are substances capable of imparting a positive or negative charge through frictional charging and are colorless, and a variety of known positive and negative charge control agents may be used.

The content of charge control agent in the toner matrix particles is preferably in the range of 0.01 to 30 mass %, and 0.1 to 10 mass % is more preferred.

### <2.2. External Additives>

It is desirable to attach an external additive to the surface of the toner matrix particles to improve toner flowability, chargeability, and cleanability.

The external additive may be inorganic or organic fine particles. Inorganic particles include silica, alumina, titania, zirconia, tin oxide, zinc oxide, stearic acid compounds such as aluminum stearate and zinc stearate, titanic acid compounds such as strontium titanate and zinc titanate. Organic fine particles include resin fine particles such as melamine resin and polytetrafluoroethylene resin, and fine particles made of styrene, methyl methacrylate, and other single polymers or copolymers of these polymers. These may be used singly or in combination of two or more type.

Silica is especially preferred, and hydrophobic silica with hydrophobic treatment is more preferred from the viewpoint of toner transferability.

Hydrophobizing agents used to hydrophobize the surface of silica particles include hexamethyldisilazane (HMDS), dimethyldichlorosilane (DMDS), silicone oil, octyltriethoxysilane (OTES), and methyltriethoxysilane.

The average particle diameter of the external additive is preferably in the range of 10 to 250 nm from the viewpoint of toner chargeability, flowability, and transferability, 15 to 200 nm is more preferred, and 15 to 90 nm is even more preferred.

The average particle diameter above is the number average particle diameter, which is obtained by measuring the particle diameter (average of the long and short diameters) of 500 particles from scanning electron microscope (SEM) photographs and determining the number average value of those particles.

From the viewpoints of toner chargeability, flowability, and transferability, the content of the external additive in the toner particles is preferably in the range of 0.05 to 5 mass % of the total mass of the toner before treatment with the external additive, it is more preferable to be in the range of 0.1 to 3 mass %, and it is even more preferable to be in the range of 0.1 to 3 mass %.

From the viewpoint of toner flowability and durability, it is preferable that the coverage of the toner matrix particles by the external additive is 50% or more, more preferably, it is 80% or more, even more preferably, it is 90% or more, and especially preferably, it is 95% or more. From the viewpoint of preventing migration of the external additive to the photoreceptor, it is preferable to be less than 200%, more preferable to be less than 170%, and even more preferable to be less than 150%.

The coverage of the toner matrix particles by the external additive may be calculated from the following formula. When two or more types of external additives are used in combination, the total coverage by the external additives is the sum of the coverage ratios calculated for each type of external additive.

Coverage (%)=(√3/2π)×{(D·ρt)/(d·ρs)}×C×100

In the formula, D is the volume-based median diameter D50 [μm] of the toner matrix particles, d is the number average particle diameter [μm] of the external additive [μm], ρt is the specific gravity of the toner matrix particles, ρs is the specific gravity of the external additive, and C is the mass ratio of the external additive to the toner matrix particles (additive/toner matrix particles).

### <3. Particle Diameter of Toner Matrix Particles>

The particle diameters of the first and second toner matrix particles are not particularly limited and may be adjusted respectively. It is preferable that the median diameter D50 on a volume basis is in the range of 4 to 10 μm, and it is more preferable that it is in the range of 4 to 7 μm. When the volume-based median diameter D50 is within the above range, the transfer efficiency is increased and the image quality such as fine lines and dots is improved.

The volume-based median diameter D50 of toner particles is measured and calculated using a measurement device that is connected to a “Coulter Counter 3” (Beckman Coulter Inc.) with a computer system (Beckman Coulter Inc.) equipped with “Software V3.51” data processing software. The data is measured and calculated using a computer system (Beckman Coulter Co., Ltd.) with data processing software “Software V3.51.

Specifically, 0.02 g of the measurement sample (toner) is added to 20 mL of surfactant solution (for the purpose of dispersing toner particles, for example, a surfactant solution made by diluting a neutral detergent containing surfactant components 10 times with pure water) and allowed to blend, then ultrasonic dispersion is performed for 1 minute to prepare the toner particle dispersion liquid. This toner particle dispersion solution is pipetted into a beaker containing “ISOTONII” (Beckman Coulter Co., Ltd.) in a sample stand until the concentration indicated on the measuring device reaches 8%.

Here, this concentration range allows reproducible measurement values to be obtained. Then, in the measurement device, the number of measured particles counted is set to 25,000 and the aperture diameter to 50 μm, the measurement range from 1 μm to 30 μm is divided into 256 parts, the frequency value is calculated, and the particle diameter 50% from the largest volume-integrated fraction is considered to be the volume-based median diameter D50.

### <4. Production Method of Toner>

The method of producing each toner included in the toner set is not particularly limited, and known methods may be employed, but the emulsion polymerization aggregation and emulsion aggregation methods are particularly suitable.

In the emulsion aggregation method, the binder resin solution dissolved in a solvent is mixed with a pigment dispersion to form a dispersion of fine resin particles. The toner particles are produced by performing shape control by further fusing between the binder resin particles.

The following is an example of each process comprising the method of producing toner matrix particles by emulsion.
(1) Process for preparing a pigment dispersion solution in which pigment particles are dispersed in an aqueous medium.
(2) Process for preparing a resin particulate dispersion solution in which binder resin particles containing an additive agent are dispersed in an aqueous medium as required.
(3) Process of mixing pigment dispersion and resin particulate dispersion to form toner matrix particles by aggregating, associating, and fusing pigment particles and binding resin particles.
(4) Process for filtering toner mother particles from the dispersion system (aqueous medium) to remove surfactants,
(5) Process of drying toner matrix particles
(6) Process of adding an external additive to the toner matrix particles

It is preferable to perform annealing treatment in the process (3) above. Annealing treatment may control the crystalline resin-derived peak endothermic value ΔH_{C} of the toner mother particle, which in turn may control the ratio (ΔH_{C1}/ΔH_{C2}) of the crystalline resin-derived peak endothermic value ΔH_{C1} of the first toner mother particle to the crystalline resin-derived peak endothermic value ΔH_{C2} of the second toner mother particle.

In the process (3) above, it is preferable to add a flocculant in order to flocculate the binder resin particles. As a flocculant, although not particularly limited, one selected from salts of metals is suitably used. For example, salts of monovalent metals such as salts of alkali metals such as sodium, potassium, and lithium; salts of divalent metals such as calcium, magnesium, manganese, and copper; and salts of trivalent metals such as iron and aluminum. Specific salts include, for example, sodium chloride, potassium chloride, lithium chloride, calcium chloride, magnesium chloride, zinc chloride, copper sulfate, magnesium sulfate, and manganese sulfate. Among these, salts of divalent metals are particularly preferred. When salts of divalent metals are used, flocculation may be promoted with smaller quantities. These may be used in one or a combination of two or more types.

The following is a specific description of an example of the process described in (3) above.

Dispersions of particles of binder resins such as a crystalline polyester resin, an amorphous polyester resin and an amorphous vinyl resin, and pigment dispersion are put into a reaction vessel equipped with a stirrer, a temperature sensor and a cooling tube, and a solution of flocculant (e.g., magnesium chloride) is added under agitation. The particles of the above binder resin and colorant are aggregated, associated and fused together to grow particles. At the desired timing, an aqueous solution of sodium chloride is added to stop the growth of particle size. Next, the temperature is raised and stirred to allow particle fusion to proceed until the average circularity of the toner particles reaches the desired value, and then the solution is cooled and the temperature is lowered.

Then, as an annealing process, the temperature is raised to 60° C. with stirring, for example, over a period of 30 minutes, and maintained at the above temperature for 3 hours. The temperature is then cooled and the liquid temperature is lowered to 30° C. or lower. Thereafter, processes (4) to (6) may be followed to produce the electrostatic charge developing toner of the present invention.

The toner matrix particles preferably have a core-shell structure, and the above method of producing toner by emulsion aggregation is suitable for producing toner matrix particles with such a core-shell structure. That is, first, the binder resin particles for the core particles and the colorant particles are aggregated, associated and fused together to prepare the core particles. Then, binder resin particles for the shell layer are added to the dispersion solution of the core particles, and the binder resin particles for the shell layer are aggregated and fused to the surface of the core particles to form a shell layer covering the surface of the core particles. This produces toner matrix particles with a core-shell structure.

A mechanical mixing device may be used for the external additive mixing treatment of the external additive to the toner matrix particles in the process (6) above. Henschel mixer, Nauta mixer, and Turbula mixer may be used as mechanical mixing equipment. Among these, it is preferable to use a mixing device such as a Henschel mixer that may impart shear force to the particles to be treated, and to perform the mixing process by lengthening the mixing time or increasing the peripheral speed of the agitator blades. When multiple types of external additives are used, all the external additives may be mixed and processed for the toner matrix particles at once, or they may be divided into multiple parts and mixed and processed according to the external additive.

Processes other than (3) above, i.e., (1), (2) and (4) to (6) above, are not particularly limited, and known methods may be suitably employed. In addition, other known processes other than the above processes (1) through (6) may be employed as long as they do not impair the expression of the effects of the present invention.

### <5. Two-Component Developer>

Each toner included in the toner set may be used as a two-component developer, for example, containing a toner and carrier particles. The two-component developer is obtained by mixing the toner and carrier particles.

The mixing equipment used for mixing is not particularly restricted, but includes, for example, Nauta mixers, W-cone and V-type mixers. The toner content (toner concentration) in the two-component developer is not particularly restricted, but it is preferably in the range of 4.0 to 12.0 mass %.

Carrier particles are composed of at least magnetic material and may be made of known materials. For example, carrier particles may be composed of coated carrier particles, in which resin is coated on the surface of core particles consisting of at least magnetic material, or dispersed carrier particles, in which magnetic fine powder is dispersed in resin.

The average diameter of the particles is preferably in the range of 10 to 500 μm, more preferably in the range of 30 to 100 μm, as the volume-based median diameter D50 measured by the same method as the toner matrix particles.

It is preferable that the carrier particles are coated carrier particles from the viewpoint of preventing the carrier particles from adhering to the photoreceptor. Coated carrier particles are explained below.

The core particles of coated carrier particles are composed of at least a magnetic material, e.g., a material that is strongly magnetized in that direction by a magnetic field. Examples of magnetic materials include ferromagnetic metals such as iron, nickel, and cobalt, alloys or compounds containing these metals, and alloys that exhibit ferromagnetism when heat treated. One of these magnetic materials may be used alone or in combination with two or more of them.

Examples of metals that exhibit ferromagnetism and alloys or compounds containing these metals include iron, ferrite represented by Formula (a) below, and magnetite represented by Formula (b) below. M in Formulas (a) and (b) represents a monovalent or divalent metal, specifically Mn, Fe, Ni, Co, Cu, Mg, Sr, Zn, Cd, or Li. One of these metals may be used alone or in combination of two or more types.

MOFe₂·O₃ Formula (a)

MFe₂O₄ Formula (b)

Examples of alloys that exhibit ferromagnetism when heat treated include Heusler alloys such as manganese-copper-aluminum and manganese-copper-tin, as well as chromium dioxide.

The magnetization of the core material particles that make up the carrier particles preferably has a saturation magnetization in the range of 30 to 75 Am2 /kg and a residual magnetization of 5.0 A·m²/kg or less. By using core particles having such magnetic properties, partial aggregation of carrier particles is prevented and the two-component developer is uniformly dispersed on the surface of the developer transfer member, thus enabling the formation of uniform, high-definition toner images without density irregularities.

The magnetic material used for the core particles is preferably ferrite from the viewpoint of obtaining suitable magnetic properties. It is also preferable for the ferrite to be porous particles having vacancies, and furthermore, the vacancies are filled with resin. This configuration allows the specific gravity to be relatively small, which suppresses cracking and chipping of the carrier particles due to the impact force of agitation in the developing machine, resulting in carrier particles with excellent durability.

As a coating resin for the coated carrier particles, any known resin used for coating the core particles of carrier particles may be used. From the viewpoint of reducing the moisture adsorption properties of the carrier particles and improving the adhesion of the coating layer to the core particles, it is preferable that the coating resin is a resin having a cycloalkyl group.

Examples of the cycloalkyl group include a cyclohexyl group, a cyclopentyl group, a cyclopropyl group, a cyclobutyl group, a cycloheptyl group, a cyclooctyl group, a cyclononyl group and a cyclodecyl group. Among these, a cyclohexyl group or cyclopentyl groups are preferred, and a cyclohexyl group is more preferred from the viewpoint of adhesion between the coating resin layer and the core particles (e.g., ferrite particles).

The resin for coating is obtained, for example, by polymerizing a polymerizable compound containing a monomer having a cycloalkyl group. Cycloalkyl esters of methacrylic acid are preferably used as monomers having a cycloalkyl group. The resin for coating may be a copolymer of the monomer and a monomer without a cycloalkyl group, for example, an alkyl (but without a cyclic structure) ester of methacrylic acid.

The weight average molecular weight Mw of the coating resin may be measured by GPC (gel permeation chromatography) and it is preferably in the range of 10,000 to 800,000, for example, and preferably in the range of 100 000 to 750,000 as a polystyrene standard.

The content of cycloalkyl groups in the coating resin is preferably in the range of 10 to 90 mass %. The content of cycloalkyl groups in the resin for coating may be determined, for example, by pyrolysis-gas chromatography/mass spectrometry (P-GC/MS) or 1H-NMR.

The thickness of the coating resin layer on the carrier particles is preferably in the range of 0.05 to 4.0 μm from the viewpoint of both durability and low electrical resistance of the carrier particles, and in the range of 0.2 to 3.0 μm is more preferred. Within the above range, the electrification and durability may be set within a desirable range.

### <6. Image Formation>

An image forming system and an image forming method using the toner set of the present invention will be described.

The figure shows a cross-sectional overview of an example of an imaging system. The figure shows an example in which four types of toner (yellow Y, magenta M, cyan C, and black K) are used as color toners, and white W toner is used as a special color toner. Two of these five toners are the first and second toners included in the toner set.

First, a schematic description of a color electrophotographic imaging system in which a detection sensor and a secondary transfer device are installed is given.

The image forming system GS is called a tandem-type color image forming system, and consists of image forming units that form yellow, magenta, cyan, and black color toner images and a white toner image, which is one type of special toner, along the direction of movement of the intermediate transfer body 36. The color toner image and white toner image formed on the image carrier of each image forming unit are multiply transferred onto the intermediate transfer media, superimposed, and then transferred in a batch onto the recording media.

In the figure, a document image placed on the image reader SC, which is located at the position occupying the upper part of the image forming system GS, is scanned and exposed by the optical system and read into the line image sensor CCD, and an analog signal photoelectrically converted by the line image sensor CCD is subjected to analog processing, A/D conversion, shading correction, and image compression processing in the image processing section, and then the image data signals are sent to the exposure optical system 33 as an image writing means.

There are two types of intermediate transfer bodies 36: a drum type and an endless belt type, both of which have similar functions, but in the following description, the term intermediate transfer body will refer to the endless belt type intermediate transfer body 36.

In the figure, five sets of process units 100 are provided on the periphery of the intermediate transfer body 36 for forming images for each color: yellow (Y), magenta (M), cyan (C), black (K), and white (W). The process units 100 are arranged in vertical rows vertically along the intermediate transfer media 36 with respect to the direction of rotation of the intermediate transfer body 36 in the vertical direction indicated by the arrows in the figure, in the order of Y, M, C, K, and W, as means of forming color toner images and white toner images.

All five sets of process units 100 have a common structure and each consists of a photoconductor drum 31, a charger 32 as a charging means, an exposure optical system 33 as an image writing means, a developer (developer) 34, and a photoreceptor cleaning unit 190 as an image carrier cleaning means.

The photoreceptor drum 31 is, for example, a photosensitive layer with a thickness of about 20 to 40 μm on the periphery of a cylindrical base formed by a metallic material such as aluminum with an outer diameter of about 40 to 100 mm. The photoreceptor drum 31 is rotated by power from a drive source, not shown, in the direction of the arrow with the base grounded, for example, at a linear speed of about 80 to 280 mm/s, preferably 220 mm/s.

Around the photoreceptor drum 31, an image forming section consisting of a charger 32 as a charging means, an exposure optical system 33 as an image writing means, and a developer 34 is arranged in the direction of rotation of the photoreceptor drum 31 as indicated by the arrow in the figure.

The charger 32 as a charging means is mounted in a direction parallel to the axis of rotation of the photoreceptor drum 31, facing and in close proximity to the photoreceptor drum 31. The charger 32 is equipped with a discharge wire as a corona discharge electrode that gives a predetermined potential to the photosensitive layer of the photoreceptor drum 31, and performs charging action (negative charging in this embodiment) by corona discharge of the same polarity as the toner, giving a uniform potential to the photoreceptor drum 31.

The exposure optical system 33, which is an image writing means, rotates and scans laser light emitted from a semiconductor laser (LD) light source (not shown) in a main scanning direction by a rotary polygon mirror (no reference numeral), exposes (writes an image) the photoreceptor drum 31 by an electric signal corresponding to an image signal via an f θ lens (no reference numeral), and a reflection mirror (no reference numeral), and forms an electrostatic latent image corresponding to an original image on a photosensitive layer of the photoreceptor drum 31.

The developer 34 as a developing means contains two-component developer of each color of a yellow (Y), magenta (M), cyan (C), black (K), and white (W) color charged with the same polarity as that of the photoreceptor drum 31, and is equipped with a cylindrical, non-magnetic stainless or aluminum equipped with a developer roller 34a, which is a developer carrier formed of a cylindrical non-magnetic stainless steel or aluminum material having a thickness of 0.5 to 1 mm and an outer diameter of 15 to 25 mm. The developer roller 34a is kept in contact with the photoreceptor drum 31 with a predetermined gap, e.g., 100 to 1000 μm, by means of a butt roller (not shown), and rotates in the same direction as the direction of rotation of the photoreceptor drum 31. During development, a DC voltage of the same polarity as the toner (negative polarity in this embodiment) or a development bias voltage in which an AC voltage is superimposed on the DC voltage is applied to the developer roller 34a, thereby performing inverse development on the exposed areas on the photoreceptor drum 31.

The intermediate transfer body 36 is a semi-conductive, non-terminated (seamless) resin belt with a volume resistivity of about 1.0×10⁷ to 1.0×10⁹ Ω-cm and a surface resistivity of about 1.0×10¹⁰ to 1.0×10¹² Ω/sq. As a resin belt, a semi-conductive resin film with a thickness of 0.05 to 0.5 mm, in which conductive materials are dispersed in engineering plastics such as modified polyimide, thermoset polyimide, ethylene tetrafluoroethylene copolymer, polyvinylidene fluoride, or nylon alloy may be used. In addition to this, a semi-conductive rubber belt of 0.5 to 2.0 mm thick in which conductive material is dispersed in silicone rubber or urethane rubber may be used as the intermediate transfer body 36. The intermediate transfer body 36 is wound by a plurality of roller members including a tension roller 36A and a backup roller 36B that faces the secondary transfer member, and is supported vertically in a rotatable manner.

The primary transfer roller 37 as the first transfer means for each color consists of a roller-shaped conductive member made of foam rubber, such as silicone or urethane, for example, and is provided facing the photoreceptor drum 31 for each color with the intermediate transfer body 36 in between, pressing the back of the intermediate transfer body 36 to form a transfer zone between it and the photoreceptor drum 31. The primary transfer roller 37 has a fixed number of rollers. A DC constant current of opposite polarity (positive polarity in this embodiment) to the toner is applied to the primary transfer roller 37 by constant current control, and the toner image on the photoreceptor drum 31 is transferred onto the intermediate transfer body 36 by the transfer electric field formed in the transfer zone.

The toner image transferred on the intermediate transfer body 36 is transferred to the recording medium P. On the circumference of the intermediate transfer body 36, is installed a detection sensor 38 that measures the density of the patch image toner.

The fixing unit 47, which fixes the transferred recording medium P, has a heating roller 47a and a pressure belt 47b, which form a nip section. Therefore, the fixing member that contacts the upper layer (toner layer) of the plurality of toner layers transferred on the recording medium P is the heating roller 47a in the figure.

A conventionally known fixing unit (not shown) that fixes with a fixing belt may be used for high-speed printing. In the fixing method using such a device that fixes the toner image with a fixing belt, the recording medium P carrying the unfixed toner image is sent to the fixing unit and guided to the nip section while being guided by the guide plate. The unfixed toner image is promptly fixed to the recording medium P by the fixing belt adhering to the recording medium P. In addition, the recording medium P receives airflow from the airflow separator at the downstream end of the fixing nip section. This promotes separation of the recording medium P from the fixing belt. The recording medium P separated from the fixing belt is guided out of the imaging system by the guide roller.

Downstream of the fixing unit 47 is installed a paper discharge roller 54 for clamping and discharging the fixed recording media P, and a paper discharge tray 55 for placing the discharged recording media P outside the machine.

On the other hand, a cleaning device 190A is provided to clean the residual toner on the intermediate transfer body 36.

In addition, a secondary transfer device 70 is provided to clean the patch image toner on the secondary transfer member 37A.

Next, the image forming method is described.

When image recording is started, a photoreceptor drive motor (not shown) is started to rotate the photoreceptor drum 31 for yellow (Y) in a direction indicated by an arrow in the drawing, and a potential is applied to the photoreceptor drum 31 for Y. The Y photoreceptor drum 31 is exposed (image writing) by an electric signal corresponding to the first color signal, i.e., Y image data, by the Y exposure optical system 33, and an electrostatic latent image corresponding to a yellow (Y) image is formed on the Y photoreceptor drum 31. This latent image is reversely developed by the Y developer 34 to form a toner image composed of yellow (Y) toner on the Y photoreceptor drum 31, and the Y toner image formed on the Y photoreceptor drum 31 is transferred onto the intermediate transfer body 36 by the primary transfer roller 7 as the primary transfer means.

Next, a potential is applied to the M photoreceptor drum 31 by the magenta (M) charger 32. After the M photoreceptor drum 31 is applied with a potential, the M exposure optical system 33 performs exposure (image writing) by means of an electric signal corresponding to the first color signal, that is, the M image data. An electrostatic latent image corresponding to the magenta (M) image is formed on the M photoreceptor drum 31. This latent image is reversely developed by the M developer 34 to form a toner image consisting of magenta (M) toner on the M photoreceptor drum 31. The M toner image formed on the M photoreceptor drum 31 is superimposed on the Y toner image by the primary transfer roller 37 as a primary transfer means and transferred onto the intermediate transfer body 36.

By the same process, a toner image consisting of cyan (C) toner formed on a cyan (C) photoreceptor drum 31 and a toner image consisting of black (K) toner formed on a black (K) photoreceptor drum 31 are successively superimposed on an intermediate transfer body 36. A superimposed color toner image made of Y, M, C and K toners is formed on the peripheral surface of the intermediate transfer body 36.

Next, the white (W) photoreceptor drum 31 is rotated in the direction indicated by the arrow in the figure, and the W charger 32 applies a potential to the W photoreceptor drum 31. After the W photoreceptor drum 31 is applied with a potential, the W exposure optical system 33 performs exposure (image writing) with an electric signal corresponding to the first color signal, that is, the W image data. An electrostatic latent image corresponding to the white (W) image is formed on the W photoreceptor drum 31. This latent image is reversely developed by the W developer 34 to form a toner image made of white (W) toner on the W photoreceptor drum 31. The W toner image formed on the W photoreceptor drum 31 is transferred onto the intermediate transfer body 36 by the primary transfer roller 7 as a primary transfer means. As a result, a superimposed color toner image consisting of Y, M, C and K toners, and a white toner image consisting of W toner on the color toner image are formed on the circumference of the intermediate transfer body 36.

The toner remaining on the circumference of each of the photoreceptor drums 31 after transfer is cleaned by the photoreceptor cleaning device 190.

On the other hand, the recording media P as recording paper stored in the paper feed cassettes 50A, 50B, and 50C is fed by the feed roller 51 and paper feed roller 52A provided in the paper feed cassettes 50A, 50B, and 50C, respectively, and is transported on the transport path 52 by the transport rollers 52B, 52C, and 52D, and the paper is conveyed through resist roller 53 to secondary transfer member 37A as a secondary transfer means to which a voltage of opposite polarity (positive polarity in this embodiment) is applied to the toner, and in the transfer zone of secondary transfer member 37A, the color toner image formed on the intermediate transfer media 36 and the white toner image on the color toner image are transferred to the recording medium. The white toner image is transferred onto the recording medium P in a batch. As a result, an image in which the lower layer is a white toner image and the upper layer is a color toner image is formed on the recording medium P.

In the example shown in the figure, the white toner image is formed underneath the color toner image. Forming the color toner image on top of the white toner image improves the visibility of the color toner and adds value as an image. However, a toner image consisting of white (W) toner or other specialty toner may be formed on the lower layer of the color toner image, depending on its intended use.

The recording medium P onto which the white and color toner images are transferred is heated and pressurized in the nip section formed by the heating roller 47a and pressure belt 47b of the fixing unit 47 to fix the image, and then placed on the paper tray 55 outside the machine, held by the paper discharge roller 54.

After the white toner image and color toner image are transferred onto the recording medium P by the secondary transfer member 37A as a secondary transfer means, the residual toner on the intermediate transfer body 36, which has separated the recording medium P in curvature, is removed by the intermediate transfer body cleaning device 190A.

Furthermore, the patch image toner on the secondary transfer member 37A is cleaned by the cleaning blade 71 of the secondary transfer device 70.

The recording media (also called media, image support, recording material, recording paper, and recording paper) used in this image forming method may be any commonly used media, and is not particularly limited. Recording media that may be used include, for example, plain paper from thin to thick, coated printing paper such as fine, art, and coated paper, commercially available Japanese paper and postcard paper, plastic film for OHP, cloth, soft transparent film, and synthetic paper such as Yupo paper. In the image forming method using the toner set of the present invention, especially when outputting on special recording media such as colored paper, black paper, aluminum evaporated paper, and transparent film, the toner set has excellent low-temperature fixation and fixation separation properties when a special toner layer is formed on the upper or lower layer of a full-color image in high-value added printing and the adhesion amount increases. Furthermore, it may prevent the toner from bleeding into the toner on the adjacent layers of the upper layer image and prevent the image density of the upper layer image from decreasing. As a result, the visibility of the color toner is improved, color reproducibility of color images is excellent, and high quality, high quality images may be formed without color bleeding or image peeling, thereby enhancing the added value of the image.

### EXAMPLES

The present invention will be specifically described below with reference to Examples, but the present invention is not limited to these. In the following examples, unless otherwise specified, operations were performed at room temperature (25° C.). Moreover, unless otherwise specified, “%” and “parts” mean “mass %” and “parts by mass” respectively.

### [Preparation of Cyan Toner 1]

### (1.1) Preparation of Amorphous Vinyl Resin Particle Dispersion Liquid X1

### (First-Stage Polymerization)

Eight parts by mass of sodium dodecyl sulfate and 3,000 parts by mass of ion-exchanged water were supplied to a 5 L reaction vessel equipped with a stirrer, a temperature sensor, a cooling tube, and a nitrogen induction device. After the temperature was raised, an aqueous solution containing 10 parts by mass of potassium persulfate dissolved in 200 parts by mass of ion-exchanged water was added to the resulting mixed liquid, and the temperature of the resulting mixed liquid was raised to 80° C. again. To the mixed liquid, monomer mixture 1 consisting of the following composition was added dropwise over 1 hour, and then polymerization was carried out by heating and stirring the mixed liquid at 80° C. for 2 hours to prepare a dispersion liquid al of resin fine particles.

### (Monomer Mixture 1)

Styrene: 480 parts by mass

n-Butyl acrylate: 250 parts by mass

Methacrylic acid: 68 parts by mass

### (Second-Stage Polymerization)

In a 5 L reaction vessel equipped with a stirrer, a temperature sensor, a cooling tube, and a nitrogen inlet device, prepare a solution of 7 parts by mass of sodium polyoxyethylene (2) dodecyl ether sulfate dissolved in 3000 parts by mass of ion-exchanged water. After heating the solution to 80° C., 80 parts by mass (in terms of solids) of dispersion liquid al containing resin particles and monomer mixture liquid 2 containing monomer and mold release agent dissolved at 90° C. was added, and dispersion liquid containing emulsified particles (oil droplets) was prepared by mixing for 1 hour using a mechanical dispersion machine “CLEARMIX” (manufactured by M-Technique Co., Ltd., CLEARMIX is their registered trademark) having a circulation route. The following hydrocarbon wax 1 is a mold release agent and its melting point is 80° C.

### (Monomer Mixture 2)

Styrene: 285 parts by mass

n-Butyl acrylate: 95 parts by mass

Methacrylic acid: 20 parts by mass

n-Octyl-3-mercaptopropionate: 8 parts by mass

Hydrocarbon wax 1 (C80, made by Sasol): 190 parts by mass

Next, an initiator solution containing 6 parts by mass of potassium persulfate dissolved in 200 parts by mass of ion-exchanged water was added to the above dispersion, and the resulting dispersion was polymerized by heating and stirring at 84° C. for 1 hour to prepare a dispersion solution a2 of resin fine particles.

### (Third-Stage Polymerization

Furthermore, 400 parts by mass of ion-exchanged water was added to the dispersion liquid a2 of resin fine particles, and after mixing thoroughly, a solution of 11 mass parts of potassium persulfate dissolved in 400 mass parts of ion-exchanged water was added to the resulting dispersion liquid, and monomer mixture liquid 3 consisting of the following composition was added dropwise over 1 hour under the temperature condition of 82° C. After the drop was completed, polymerization was carried out by heating and stirring the dispersion solution for 2 hours.

### (Monomer Mixture 3)

Styrene: 307 parts by mass

n-Butyl acrylate: 147 parts by mass

Methacrylic acid: 52 parts by mass

n-Octyl-3-mercaptopropionate: 8 parts by mass

Thereafter, it was cooled to 28° C. to prepare an amorphous vinyl resin particle dispersion liquid X1 consisting of vinyl resin (styrene-acrylic resin).

When the physical properties of the obtained amorphous vinyl resin particulate dispersion X1 were measured, the volume-based median diameter D50 of the amorphous vinyl resin particulates was 220 nm, the glass transition point Tg was 46° C., and the weight average molecular weight Mw was 32,000.

### (1.2) Preparation of Crystalline Polyester Resin Particulate Dispersion Liquid Y1

Two hundred eighty-one (281) parts by mass of sebacic acid and 283 parts by mass of 1,10-decanediol were placed in a reaction vessel equipped with a stirrer, a thermometer, a cooling tube, and a nitrogen gas inlet tube. After replacing the reaction vessel with dry nitrogen gas, 0.1 parts by mass of Ti(OBu)₄ was added, and the resulting mixture was stirred at about 180° C. for 8 hours under nitrogen gas flow. Furthermore, 0.2 parts by mass of Ti(OBu)₄ was added to the mixture, the temperature of the mixture was raised to about 220° C., the mixture was stirred for 6 hours, and the reaction was carried out. Thereafter, the pressure in the reaction vessel was reduced to 1333.2 Pa, and the reaction was carried out under reduced pressure to obtain a crystalline polyester resin P1.

The number average molecular weight Mn of crystalline polyester resin P1 was 5,500, the weight average molecular weight Mw was 18,000, and the melting point Tm was 70° C.

30 parts by mass of the crystalline polyester resin P1 was melted and transferred to an emulsion-dispersion machine “CAVITRON CD1010” (manufactured by Eurotech) at a transfer rate of 100 parts by mass per minute. At the same time, dilute ammonia water with a concentration of 0.37 mass % was transferred to the emulsifying-dispersion machine at a transfer rate of 0.1 L per minute while heated to 100° C. in a heat exchanger. The dilute ammonia water was prepared by diluting 70 parts by mass of reagent ammonia water with ion exchanged water in an aqueous solvent tank. Then, the crystalline polyester resin particle dispersion liquid Y1 with a solid content of 30 mass parts was prepared by operating the emulsifying-dispersion machine at a rotor speed of 60 Hz and a pressure of 5 kg/cm² (490 kPa).

When the physical properties of the resulting crystalline polyester resin particle dispersion Y1 were measured, the volume-based median diameter D50 of the crystalline polyester resin particulates was 200 nm.

### (1.3) Preparation of Hybrid Amorphous Polyester Resin Particle Dispersion Liquid S1

Monomer mixture 4, consisting of the following composition including bi-reactive monomer (acrylic acid), was placed in a dropping funnel. Note that di-t-butyl peroxide is the polymerization initiator.

(Monomer mixture 4)

Styrene: 80 parts by mass

n-Butyl acrylate: 20 parts by mass

Acrylic acid: 10 parts by mass

di-t-Butyl peroxide: 16 parts by mass

The following raw monomers for amorphous polyester polymer segments were placed in a four-neck flask equipped with a nitrogen inlet tube, a dehydration tube, a stirrer, and a thermocouple, and heated to 170° C. to dissolve them.

### (Raw Monomer for Amorphous Polyester Polymer Segment)

Bisphenol A propylene oxide 2-mole adduct: 285.7 parts by mass

Terephthalic acid: 66.9 parts by mass

Fumaric acid: 47.4 parts by mass

Then, monomer mixture 6 was dropped into the resulting solution over 90 minutes under stirring, and after ripening for 60 minutes, unreacted monomers from the components of the monomer mixture 4 were removed from the four-neck flask under reduced pressure (8 kPa).

Then, 0.4 parts by mass of Ti(OBu)₄ was added as an esterification catalyst in a quart flask, and the temperature of the mixture in the quart flask was raised to 235° C. The reaction was conducted under normal pressure (101.3 kPa) for 5 hours and then under reduced pressure (8 kPa) for 1 hour to obtain a hybrid amorphous polyester resin s1. The number average molecular weight and weight average molecular weight of the hybrid amorphous polyester resin s1 were 10,500 and 29,500, respectively.

100 parts by pass of the hybrid amorphous polyester resin sl was dissolved in 400 parts by mass of ethyl acetate (Kanto Chemical Co., Ltd.) and mixed with 638 parts by mass of a previously prepared 0.26 mass % concentration sodium lauryl sulfate solution.

The resulting mixture was dispersed by ultrasonic homogenizer “US-150T” (Nippon Seiki Mfg. Co., Ltd.) with stirring for 30 minutes at a V-LEVEL of 300 μA.

Thereafter, the aforementioned mixed liquid was stirred for 3 hours under reduced pressure using a diaphragm vacuum pump “V-700” (BUCHI) while heated to 40° C. to completely remove ethyl acetate. Thus, a hybrid amorphous polyester resin particulate dispersion liquid (dispersion liquid for shell) S1 with a solid content of 13.5 mass % was prepared.

When the physical properties of the obtained S1 dispersion of hybrid amorphous polyester resin particles were measured, the volume-based median diameter D50 of the hybrid amorphous polyester resin particles was 160 nm.

### (1.4) Preparation of Cyan Pigment Dispersion Liquid C1

90 parts by mass of sodium dodecyl sulfate was stirred and dissolved in 1600 parts by mass of ion-exchanged water, and 420 parts by mass of C.I. Pigment Blue 18:3 was gradually added while stirring this solution.

Then, a cyan pigment dispersion liquid C1 was prepared by dispersion processing the resulting dispersion solution using the “CLEARMIX” agitator (manufactured by M Technique Co., Ltd.).

The volume-based median diameter D50 of the pigment in the cyan pigment dispersion C1 was measured using a Microtrac particle size analyzer “UPA-150” (Nikkiso) and it was 150 nm.

### (1.5) Production of Toner Matrix Particles

In a reaction vessel equipped with a stirrer, a temperature sensor, and a cooling pipe, 288 parts by mass (solid content equivalent) of amorphous vinyl resin particulate dispersion liquid X1 and 2,000 parts by mass of ion-exchanged water were added, and then 5 mol/L sodium hydroxide solution was added to further adjust the pH of the dispersion liquid in the reaction vessel to 10 (measurement temperature: 25° C.).

Thirty parts by mass (in terms of solid content) of cyan pigment dispersion liquid C1 was added to the dispersion liquid. Next, an aqueous solution of 30 parts by mass of magnesium chloride dissolved in 60 parts by mass of ion-exchanged water as a flocculant was added to the dispersion at 30° C. for 10 minutes under agitation. The temperature of the resulting mixed liquid was raised to 80° C., then 40 parts by mass (in terms of solid content) of crystalline polyester resin particulate dispersion Y1 was added to the aforementioned mixed liquid over a period of 10 minutes to progress aggregation.

The particle diameters of the particles aggregated in the aforementioned mixture were measured using a Coulter Multisizer 3 (Beckman Coulter), and when the volume-based median diameter D50 of the particles reached 6.0 μm, 37 parts by mass (solid content equivalent) of hybrid amorphous polyester resin particulate dispersion liquid (dispersion liquid for shell) S1 was fed into the above mixture over a period of 30 minutes. When the supernatant of the resulting reaction solution became clear, a solution of 190 parts by mass of sodium chloride dissolved in 760 parts by mass of ion-exchanged water was added to the aforementioned reaction solution to stop particle growth.

Furthermore, by heating and stirring the reaction liquid to 80° C., particle fusion was progressed, and the particles in the reaction liquid were measured (4,000 HPF detected) using a measuring device “FPIA-2100” (Sysmex), and when the average circularity of the particles reached 0.945, the aforementioned reaction solution was cooled to 30° C. at a cooling rate of 2.5° C./min.

The temperature was then raised to 60° C. over a period of 30 minutes with stirring, and annealing was performed at an annealing temperature of 60° C. and an annealing time of 3 hours. The temperature was then cooled to 30° C.

The particles were then separated from the cooled reaction solution, dehydrated, and the resulting cake was washed three times by redispersion in ion-exchange water and solid-liquid separation, followed by drying at 40° C. for 24 hours to obtain toner matrix particles B1.

Using a Perkin Elmer DSC-7 differential scanning calorimeter, the peak endothermic value ΔH_{C} derived from the crystalline resin of toner matrix particle B1 was measured by the method described above, and the result was 11.5 kJ/g.

### (1.6) Mixing of External Additives

To 100 parts by mass of toner matrix particles B1, 0.6 parts by mass of hydrophobic silica (average primary particle diameter=12 nm, hydrophobicity =68) and 1.0 part by mass of hydrophobic titanium dioxide (average primary particle diameter=20 nm, hydrophobicity =63) were added, and these were mixed using a “Henschel mixer” (manufactured by Nippon Coke Industry Co. After mixing for 20 minutes at 32° C. with a rotary blade peripheral speed of 35 mm/second, coarse particles were removed using a 45 μm mesh opening sieve. Cyan toner 1 was prepared by performing such an external additive treatment.

### [Preparation of Cyan Toners 2 to 4]

Cyan toners 2 through 4 were each prepared in the same manner as in the preparation of cyan toner 1 above, except that the amount of each dispersion and annealing treatment conditions were changed as described in Table I.

The peak endothermal values ΔH_{C} derived from the crystalline resin of the toner matrix particles in cyan toners 2 to 4 are shown in Table I.

### [3. Preparation of Fluorescent Toner 1]

Twenty grams of fluorescent pigment having the structure represented by the following Formula (K-1) was dissolved in 450 g of ethyl acetate. The dissolved solution was added dropwise to 750 g of an aqueous solution containing 8 g of surfactant “Aqualon KH-05” (manufactured by Dai-ichi Kogyo Seiyaku), stirred, and then emulsified for 15 seconds using “CLEARMIX W Motion CLM-0.8W” (manufactured by M Technique Co., Ltd.). The emulsion was then treated with ethyl acetate under reduced pressure. Thereafter, ethyl acetate was removed under reduced pressure to obtain a fluorescent pigment dispersion solution.

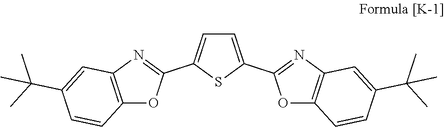 [SMILES: CC(C)(C)c1ccc2oc(-c3ccc(-c4nc5cc(C(C)(C)C)ccc5o4)s3)nc2c1]

The volume-based median diameter D50 of the pigment in the fluorescent pigment dispersion was measured using an electrophoretic light scattering spectrophotometer “ELS-800” (Otsuka Electronics), and it was 4

Fluorescent toner 1 was prepared in the same manner as in the preparation of cyan toner 1 above, except that the above fluorescent pigment dispersion was used instead of cyan pigment dispersion C1, and furthermore, the input amount of each dispersion and annealing treatment conditions were changed as described in Table I.

The peak endothermal values ΔH_{C} derived from the crystalline resin of the toner matrix particles in fluorescent toner 1 are shown in Table I.

### [4. Preparation of Black Toners 1 to 6]

Ninety parts by mass of sodium dodecyl sulfate was added to 1,600 parts by mass of ion-exchanged water, and 420 parts by mass of carbon black (Regal 330R; manufactured by Cabot) as black pigment was gradually added while stirring the solution. The black pigment dispersion solution was then obtained by dispersion processing using a mechanical dispersion machine (CLEARMIX; M Technique Co., Ltd.).

The volume-based median diameter D50 of the pigment in the black pigment dispersion was 110 nm, as measured by an electrophoretic light scattering spectrophotometer (ELS-800; Otsuka Electronics Co.

In the preparation of cyan toner 1 above, black toners 1 to 6 were each prepared in the same manner, except that the above black pigment dispersion was used instead of cyan pigment dispersion C1, and further, the input amount of each dispersion and annealing treatment conditions were changed as described in Table I.

The peak endothermal values ΔH_{C} derived from the crystalline resin of the toner matrix particles in black toners 1 to 6 are shown in Table I.

### [5. Preparation of Glitter Toner 1]

As the glitter pigment, 210 parts by mass of aluminum pigment (Showa Aluminum Powder Co., Ltd., 260EA, average particle diameter 10 nm), from which solvent was removed from the paste, was added to a surfactant solution containing 1 mass % sodium alkyl diphenyl ether disulfonate dissolved in 480 parts by mass of ion-exchange water. The dispersion was then dispersed using an ultrasonic homogenizer to prepare the glitter pigment dispersion. The solid concentration (content of glitter pigment) in the glitter pigment dispersion was adjusted to 30 mass %. The average particle diameter of the glitter pigment in the glitter pigment dispersion was 4

In the preparation of cyan toner 1 above, the above glitter pigment dispersion was used instead of cyan pigment dispersion C1, and furthermore, the input amount of each dispersion and annealing treatment conditions were changed as described in Table I, thus glitter toner 1 was prepared in the same way.

The peak endothermal value ΔH_{C} derived from the crystalline resin of the toner matrix particles in the glitter toner 1 are shown in Table I.

### [6. Preparation of White Toner 1]

### (6.1) Preparation of Crystalline Polyester Resin Particle Dispersion Liquid

In a heated and dried three-necked flask, 266 parts by mass of 1,12-dodecanedicarboxylic acid, 169 parts by mass of 1,10-decanediol, and 0.035 parts by mass of tetrabutoxy titanate as a catalyst were added, then the air in the vessel was reduced by decompression operation. The air in the vessel was then depressurized and an inert atmosphere was created by nitrogen gas, and refluxing was carried out at 180° C. for 6 hours with mechanical stirring.

The temperature was then gradually increased to 220° C. by vacuum distillation and stirred for 2.5 hours. When the system became viscous, the resin acid number was measured, and when it reached 15.0 mg KOH/g, vacuum distillation was stopped and the resin was cooled to obtain a crystalline polyester resin.

The weight average molecular weight Mw of the obtained crystalline polyester resin was measured by the method described above and it was 13,000. The melting temperature of the obtained crystalline polyester resin was measured using a differential scanning calorimeter (DSC) and it was 73° C.

Next, 180 parts by mass of the above crystalline polyester resin and 585 parts by mass of deionized water were placed in a stainless steel beaker, the beaker was placed in a warm bath, and heated to 95° C. When the crystalline polyester resin melted, the mixture was stirred at 8,000 rpm using a homogenizer (made by IKA, ULTRA-TURRAX T50), and diluted ammonia water was added to adjust the pH to 7.0. Then, 20 parts by mass of an aqueous solution containing 0.8 parts by mass of an anionic surfactant (Neogen R, made by Dai-ichi Kogyo Seiyaku) was added dropwise, and emulsion dispersion was performed to prepare a crystalline polyester resin particle dispersion liquid (resin particle concentration 40 mass %) with a volume average particle size of 0.23 μm.

### (6.2) Preparation of Amorphous Polyester Resin Particle Dispersion Liquid

In a heated and dried two-necked flask, 74 parts by mass of dimethyl adipate, 192 parts by mass of dimethyl terephthalate, 216 parts by mass of bisphenol A ethylene oxide adduct, 38 parts by mass of ethylene glycol, and 0.037 parts by mass of tetrabutoxy titanate as catalyst were placed in the vessel. Nitrogen gas was introduced into the vessel to maintain an inert atmosphere, and the temperature was raised while stirring, followed by a copolymerization reaction at 160° C. for about 7 hours.

The temperature was then raised to 220° C. while gradually reducing the pressure to 10 Torr and held for 4 hours. The pressure was returned to normal, 9 parts by mass of anhydrous trimellitic acid was added, and the pressure was again gradually reduced to 10 Torr and held for 1 hour to obtain an amorphous polyester resin.

The glass transition point of the resulting amorphous polyester resin was measured using a differential scanning calorimeter (DSC) according to the aforementioned measurement method, and it was 60° C. The molecular weight of the obtained amorphous polyester resin was measured by GPC using the aforementioned measurement method, and the weight average molecular weight Mw was 12,000. The acid number of the obtained amorphous polyester resin was measured, and it was 25.0 mg KOH/g.

Next, 115 parts by mass of the above amorphous polyester resin, 180 parts by mass of deionized water, and 5 parts by mass of an anionic surfactant (Neogen R, Dai-ichi Kogyo Seiyaku) were mixed, heated to 120° C., and dispersed using a homogenizer (ULTRA-TURRAX T50, made by IKA). Then, a dispersion of amorphous polyester resin fine particles (concentration of fine resin particles: 40% by mass) was prepared by carrying out dispersion treatment for one hour using a pressure-discharging Gaulin homogenizer.

### (6.3) Preparation of White Pigment Dispersion

The following ingredients were mixed, dissolved, and dispersed using a high-pressure impact disperser Ultimizer (HJP30006, Sugino Machine Co., Ltd.) for about 1.5 hours to prepare white a pigment dispersion liquid W1.

Titanium dioxide (Ishihara Sangyo's A-220, primary particle diameter 0.16 μm): 100 parts by mass

Anionic surfactant (Neogen R, manufactured by Dai-ichi Kogyo Seiyaku): 15 parts by mass

Ion-exchanged water: 400 mass parts

The volume average particle size of titanium dioxide in the white pigment dispersion obtained was measured using a laser diffraction particle size analyzer, and the volume average particle size was 0.285 μm. The solid content ratio of the white pigment dispersion was 23 mass %.

### (6.4) Preparation of Mold Release Agent Dispersion Liquid

90 parts by mass of Fischer-Tropsch wax FNP92 (melting temperature 92° C., Nippon Seiro), 3.6 parts by mass of anionic surfactant (Neogen R, Dai-ichi Kogyo Seiyaku), and 369 parts by mass of ion-exchanged water were mixed. The mixture was heated to 100° C. and thoroughly dispersed in a homogenizer (ULTRA-TURRAX T50, made by IKA), and then further dispersed in a pressure-discharge Gaulin homogenizer to obtain a release agent dispersion liquid. The volume average particle size of the release agent in the resulting release agent dispersion was measured using a laser diffraction particle size analyzer, and the volume average particle size was 0.23 μm.

The solid content ratio of the release agent dispersion was 20 mass %.

### (6.5) Production of Toner Matrix Particles

5.4 parts by mass (solid content equivalent) of crystalline polyester resin particulate dispersion liquid, 126.6 parts by mass (solid content equivalent) of amorphous polyester resin particulate dispersion liquid, 90.0 parts by mass (solid content equivalent) of white pigment dispersion liquid, 18.0 parts by mass (solid content equivalent) of mold release agent dispersion liquid, and 484 parts by mass of deionized water were thoroughly mixed and dispersed in a round stainless steel flask using an ULTRA-TURRAX T50.

Next, 0.37 parts by mass of polyaluminum chloride was added to it, and the dispersion operation was continued with ULTRA-TURRAX. The flask was further heated to 52° C. while stirring in a heating oil bath; after holding at 52° C. for 3 hours, 60 parts by mass (in terms of solid content) of the amorphous polyester resin particulate dispersion was gently added here.

The pH in the system was then reduced to 8.5 with a 0.5 N sodium hydroxide solution, the stainless steel flask was then sealed, heated to 90° C. with continuous stirring using a magnetic seal, and the system was maintained for 3.5 hours.

After completion of the reaction, the product was cooled, filtered, washed thoroughly with ion-exchanged water, and solid-liquid separation was performed by Nutsche-type suction filtration. This was further re-dispersed in 3 L of ion-exchanged water at 40° C., stirred and washed at 300 rpm for 15 minutes. This was repeated five more times, and solid-liquid separation was carried out by Nutsche suction filtration using No. 5A filter paper, followed by vacuum drying for 12 hours to obtain the toner matrix particles of white toner 1.

The volume-based median diameter D50 of the toner matrix particles of white toner 1 was 6.5 μm.

The peak endothermic value ΔH_{C} derived from the crystalline resin of the toner matrix particles was measured by the method described above using a Perkin Elmer DSC-7 differential scanning calorimeter, and the result was 0.58 kJ/g.

### (6.6) Mixing of External Additives

White toner 1 was obtained by adding 1 pats by mass of hydrophobic silica particles (RY-50 manufactured by AEROSIL JAPAN) to 100 part by mass of toner matrix particles and mixing by external attachment using a Henschel mixer.

TABLE I

| | Toner matrix particles | | | | | |
|---|---|---|---|---|---|---|
| | | | | | Amorphous polyester resin + | |
| | Pigment | | Crystalline polyester resin | | Wax (mold release agent) | |
| | Input amount | Content | Input amount | Content | Input amount | Content |
| | in solid content | ratio W_{P} | in solid content | ratio W_{C} | in solid content | ratio |
| | [parts by mass] | [wt %] | [parts by mass] | [wt %] | [parts by mass] | [wt %] |
| Cyan toner 1 | 30 | 8 | 40 | 10 | 288 | 73 |
| Cyan toner 2 | 30 | 8 | 40 | 10 | 288 | 73 |
| Cyan toner 3 | 30 | 8 | 50 | 13 | 278 | 70 |
| Cyan toner 4 | 30 | 8 | 60 | 15 | 268 | 68 |
| Fluorescent toner 1 | 36 | 9 | 40 | 10 | 288 | 72 |
| Black toner 1 | 156 | 30 | 10 | 2 | 318 | 61 |
| Black toner 2 | 156 | 30 | 10 | 2 | 318 | 61 |
| Black toner 3 | 97 | 21 | 10 | 2 | 318 | 69 |
| Black toner 4 | 156 | 30 | 20 | 4 | 308 | 59 |
| Black toner 5 | 75 | 17 | 10 | 2 | 318 | 72 |
| Black toner 6 | 156 | 30 | 10 | 2 | 318 | 61 |
| Glitter toner 1 | 156 | 30 | 10 | 2 | 318 | 61 |
| White toner 1 | 90 | 30 | 5 | 2 | 18 | 6 |

| | Toner matrix particles | | | | |
|---|---|---|---|---|---|
| | Amorphous polyester resin | | Annealing treatmen | | Peak |
| | Input amount | Content | Annealing | Annealing | endothermic |
| | in solid content | ratio | temperature | time | value ΔH_{C} |
| | [parts by mass] | [wt %] | [° C.] | [h] | [kJ/g] |
| Cyan toner 1 | 37 | 9 | 60 | 3 | 11.5 |
| Cyan toner 2 | 37 | 9 | 45 | 3 | 7.2 |
| Cyan toner 3 | 37 | 9 | 60 | 6 | 15.4 |
| Cyan toner 4 | 37 | 9 | 60 | 3 | 14.3 |
| Fluorescent toner 1 | 37 | 9 | 60 | 3 | 11.5 |
| Black toner 1 | 37 | 7 | 30 | 1 | 0.58 |
| Black toner 2 | 37 | 7 | 40 | 1 | 1.15 |
| Black toner 3 | 37 | 8 | 30 | 1 | 0.58 |
| Black toner 4 | 37 | 7 | 60 | 2 | 4.00 |
| Black toner 5 | 37 | 8 | 30 | 1 | 0.58 |
| Black toner 6 | 37 | 7 | 38 | 1 | 1.04 |
| Glitter toner 1 | 37 | 7 | 30 | 1 | 0.58 |
| White toner 1 | 187 | 62 | None | None | 0.58 |

0.5 g of each toner was placed in a 10-mL glass bottle with an inner diameter of 21 mm, the lid was closed, and the bottle was shaken 600 times at room temperature with a tap denser KYT-2000 (Seishin Kogyo Co., Ltd.). The toner was then placed on a 48-mesh sieve (350 μm in aperture), being careful not to break up toner agglomerates, and set on a powder tester (Hosokawa Micron Co., Ltd.). The toner mass [g] was measured.

Toner aggregation ratio [%] was calculated using the following formula.

Toner aggregation ratio [%]=toner mass on sieve [g]/0.5 g×100

The following criteria were used to evaluate the heat storage resistance of the toner. The evaluation results are shown in Table II.

Circle: Toner aggregation ratio is less than 15% (Toner has good thermal storage resistance)

Triangle: Toner aggregation ratio of 15% or more (Toner's heat storage resistance is poor and not favorable for use)

### [8. Evaluation of Color Development]

A two-component developer containing each toner was prepared by adding a ferrite carrier with a volume average particle diameter of 32 μm coated with acrylic resin to each of the above toners and mixing them so that the toner particle concentration was 6 mass %.

The fixing unit of a commercially available full-color multifunction printer, bizhub PRO C6501 (Konica Minolta Business Technologies, Inc.), was modified so that the surface temperature of the fixing heat roller may be changed in the range of 100 to 210° C.

Using the modified full-color copier and a two-component developer containing each toner, A4 (basis weight 80 g/m²) plain paper was fed vertically and a 5 mm wide solid band image extending perpendicular to the direction of feed was fixed. The fixing temperature was set at 180° C.

Three subjects were asked to evaluate the desirable color development of the solid band image. The superiority or inferiority of the color development of the evaluation results was expressed in the following ranks.

The evaluation results are shown in Table II. Circle: Color development is desirable.

Triangle: Some difficulty in color development.

Cross mark: There is a problem with color development.

### [9. Evaluation of Fixability]

Each toner produced was combined as shown in Table II to make toner sets 1 to 12, including the first and second toners.

Each two-component developer containing each toner was prepared by adding and mixing a ferrite carrier with a volume average particle diameter of 32 μm coated with acrylic resin to each toner contained by the toner set, so that the toner particle concentration was 6 mass %.

The fixing unit of a commercially available full-color multifunction printer, bizhub PRO C6501 (Konica Minolta Business Technologies, Inc.), was modified so that the surface temperature of the heat roller for fixing may be changed in the range of 100 to 210° C.

Using the modified full-color copier and a two-component developer containing each toner, an unfixed solid image was formed on a ULIKE 152 g/m² (made by Nippon Paper Industries) under normal temperature and humidity (20° C., 50% RH), with the adhesion of the upper layer at 2.5 g/m² and the lower layer at 20 g/m². The upper layer was formed with the second toner and the lower layer was formed with the first toner.

Next, the surface temperature of the pressure roller of the fixing unit was set at 140° C., and the surface temperature of the heating roller was changed in 2° C. increments from 140 to 180° C. The fixing lower limit temperature of the upper fixing belt at which under-offset does not occur was measured. The lower limit of fixing temperature was measured for both toners under the different storage conditions described above.

Fixation was evaluated based on the following evaluation criteria. The symbols “Circle” and “Triangle” were considered acceptable. The evaluation results are shown in Table II.

Circle: The lower limit of fixing temperature is 148° C. or less.

Triangle: The lower limit of fixing temperature is 150 to 154° C.

Cross mark: The lower limit of fixing temperature is 156° C. or higher.

TABLE II

| | First toner | | | | Second toner | | | |
|---|---|---|---|---|---|---|---|---|
| | | Pigment | Crystalline | Peak | | Pigment | Crystalline | Peak |
| Toner | | content | resin content | endothermic | | content | resin content | endothermic |
| set | | ratio W_{P1} | ratio W_{C1} | value ΔH_{C1} | | ratio W_{C2} | ratio W_{C2} | value ΔH_{C2} |
| No. | Type | [wt %] | [wt %] | [kJ/g] | Type | [wt %] | [wt %] | [kJ/g] |
| 1 | Black toner 1 | 30 | 2 | 0.58 | Cyan toner 1 | 8 | 10 | 11.5 |
| 2 | White toner 1 | 30 | 2 | 0.58 | Cyan toner 1 | 8 | 10 | 11.5 |
| 3 | Glitter toner 1 | 30 | 2 | 0.58 | Fluorescent | 9 | 10 | 11.5 |
| | | | | | toner 1 | | | |
| 4 | Black toner 2 | 30 | 2 | 1.15 | Cyan toner 1 | 8 | 10 | 11.5 |
| 5 | Black toner 1 | 30 | 2 | 0.58 | Cyan toner 2 | 8 | 10 | 7.2 |
| 6 | Black toner 1 | 30 | 2 | 0.58 | Cyan toner 3 | 8 | 13 | 15.4 |
| 7 | Black toner 3 | 21 | 2 | 0.58 | Cyan toner 1 | 8 | 10 | 11.5 |
| 8 | Black toner 1 | 30 | 2 | 0.58 | Cyan toner 4 | 8 | 15 | 14.3 |
| 9 | Black toner 4 | 30 | 4 | 4.00 | Cyan toner 2 | 8 | 10 | 7.2 |
| 10 | Black toner 5 | 17 | 2 | 0.58 | Cyan toner 1 | 8 | 10 | 11.5 |
| 11 | Black toner 2 | 30 | 2 | 1.15 | Cyan toner 2 | 8 | 10 | 7.2 |
| 12 | Black toner 6 | 30 | 2 | 1.04 | Cyan toner 2 | 8 | 10 | 7.2 |

| | | | Evaluation | | | | | |
|---|---|---|---|---|---|---|---|---|
| | | | | First toner | Second toner | | | |
| | | | | Heat | Heat | First toner | Second toner | |
| Toner | | | | storage | storage | Color | Color | |
| set | W_{P1} − W_{P2} | ΔH_{C1}/ΔH_{C2} | Fixability | resistance | resistance | development | development | Remarks |
| 1 | 22 | 0.05 | ∘ | ∘ | ∘ | ∘ | ∘ | Present Invention |
| 2 | 22 | 0.05 | ∘ | ∘ | ∘ | ∘ | ∘ | Present Invention |
| 3 | 21 | 0.05 | ∘ | ∘ | ∘ | ∘ | ∘ | Present Invention |
| 4 | 22 | 0.10 | Δ | ∘ | ∘ | ∘ | ∘ | Present Invention |
| 5 | 22 | 0.08 | ∘ | ∘ | Δ | ∘ | ∘ | Present Invention |
| 6 | 22 | 0.04 | Δ | ∘ | ∘ | ∘ | ∘ | Present Invention |
| 7 | 13 | 0.05 | ∘ | Δ | ∘ | Δ | ∘ | Present Invention |
| 8 | 22 | 0.04 | ∘ | ∘ | Δ | ∘ | ∘ | Present Invention |
| 9 | 22 | 0.56 | x | ∘ | Δ | ∘ | ∘ | Comparative Example |
| 10 | 9 | 0.05 | ∘ | ∘ | ∘ | x | ∘ | Comparative Example |
| 11 | 22 | 0.16 | x | ∘ | Δ | ∘ | ∘ | Comparative Example |
| 12 | 22 | 0.14 | Δ | ∘ | Δ | ∘ | ∘ | Present Invention |

The above evaluation results show that the toner set of the present invention has good color development, thermal storage resistance, and fixing properties.

Although embodiments of the present invention have been described and illustrated in detail, the disclosed embodiments are made for purposes of illustration and example only and not limitation. The scope of the present invention should be interpreted by terms of the appended claims

### REFERENCE SIGNS LIST

31: Photoreceptor drum

32: Electrostatic charger

33: Exposure optics as a means of writing images

34: Developer

34a: Developing roller

36: Intermediate transfer body

36a: Tension roller

36B: Backup roller

37: Primary transfer roller

37A: Secondary transfer member

38: Detection sensor

47: Fixing unit

47a: Heating roller

47b: Pressure belt

50A, 50B, 50C: Paper feeding cassette

51: Feed roller

52: Transfer path

52A: Paper feed roller

52B, 52C, 52D: Transfer rollers

53: Resist roller

54: Discharge roller

55: Paper discharge tray

70: Secondary transfer device

100: Process units of yellow (Y), magenta (M), cyan (C), black (K) and white (W)

190: Photoreceptor cleaning device as an image carrier cleaning means

190A: Intermediate transfer body cleaning device

GS: Image forming systems

SC: Image reader

CCD: Line image sensor

P: Recording media

1. A toner set for developing an electrostatic charge image, including a first toner and a second toner whose toner matrix particles contain different types of pigments,
wherein the first toner matrix particles included in the first toner and the second toner matrix particles included in the second toner both contain at least the pigment and a crystalline resin; and the first toner and the second toner satisfy the following Expressions (1A) and (2A),
10≤W_{P1}−W_{P2} Expression (1A)
ΔH_{C1}/ΔH_{C2}≤0.15. Expression (2A)
W_{P1}: a pigment content of the first toner matrix particle [mass %]
W_{P2}: a pigment content of the second toner matrix particle [mass %]
ΔH_{C1}: a peak endothermic value derived from the crystalline resin of the first toner matrix particle [kJ/g]
ΔH_{C2}: a peak endothermic value derived from the crystalline resin of the second toner matrix particle [kJ/g].

2. The toner set for developing an electrostatic charge image according to claim 1, wherein the first toner and the second toner satisfy the following Expression (2B),
ΔH_{C1}/ΔH_{C2}≤0.08, Expression (2B)
ΔH_{C1}: a peak endothermic value derived from the crystalline resin of the first toner matrix particle [kJ/g]
ΔH_{C2}: a peak endothermic value derived from the crystalline resin of the second toner matrix particle [kJ/g].

3. The toner set for developing an electrostatic charge image according to claim 1, wherein the peak endothermic value ΔH_{C2} derived from the crystalline resin of the second toner matrix particle is in the range of 8 to 15 kJ/g.

4. The toner set for developing an electrostatic charge image according to claim 1, wherein the pigment content W_{P1} of the first toner matrix particle is 30 mass % or more.

5. The toner set for developing an electrostatic charge image according to claim 1, wherein a crystalline resin content W_{C2} of the second toner matrix particle is in the range of 5 to 10 mass %.

6. The toner set for developing an electrostatic charge image according to claim 1, wherein a crystalline resin content W_{C2} of the second toner matrix particle is in the range of 2 to 10 mass %.

7. The toner set for developing an electrostatic charge image according to claim 1, wherein the pigment contained in the second toner matrix particle is an organic pigment.

8. The toner set for developing an electrostatic charge image according to claim 1, wherein the pigment contained in the first toner matrix particle is an inorganic pigment.

9. An image forming system using the toner set for developing an electrostatic charge image according to claim 1.

10. An image forming method using the toner set for developing an electrostatic charge image according to claim 1.
